(19) United States
(12) Patent Application Publication
(10) Pub. No.: US 2012/0213542 A1
(43) Pub. Date: Aug. 23, 2012

(54) Image Forming Apparatus, Image Forming Method, and Recovery Device

(75) Inventors: Yuichiro TSUKADA, Shiojiri-shi (JP); Tsutomu SASAKI, Matsumoto-shi (JP); Kazuhiro NISHIYAMA, Shiojiri-shi (JP); Kazuma MIYAZAWA, Shiojiri-shi (JP); Naoyuki OKUMURA, Nagano-ken (JP)

(73) Assignee: SEIKO EPSON CORPORATION, Tokyo (JP)

(21) Appl. No.: 13/397,059

(22) Filed: Feb. 15, 2012

(30) Foreign Application Priority Data
Feb. 22, 2011 (JP) 2011-035834
Apr. 25, 2011 (JP) 2011-097338
Apr. 25, 2011 (JP) 2011-097339

(51) Int. Cl. G03G 15/24; G03G 13/24; G03G 21/10

(52) U.S. Cl. 399/71; 399/150; 399/348

(57) ABSTRACT

A developing roller which comes into contact with a latent image carrier drum on a first side with respect to an imaginary vertical plane passing through the rotation center of the latent image carrier drum, thereby developing a latent image which is carried on the latent image carrier drum by a liquid developer that includes toner and carrier liquid is provided, and a squeeze roller which comes into contact with the latent image carrier drum developed by the developing roller on a second side on the opposite side to the first side with respect to the imaginary vertical plane further on the upper side in the vertical direction than an imaginary horizontal plane passing through the rotation center of the latent image carrier drum and perpendicular to the imaginary vertical plane, thereby squeezing an image developed to the latent image carrier drum is provided.

### BACKGROUND

1. Technical Field

The present invention relates to an image forming apparatus and an image forming method, which form an image developed by a liquid developer chat includes carrier liquid and toner particles, and a recovery device which recovers a liquid developer that includes toner and carrier liquid from a carrier such as a latent image carrier drum, and an image forming apparatus which is provided with the recovery device.

2. Related Art

In the past, a liquid development type of image forming apparatus made such that an electrostatic latent image is formed on a latent image carrier drum such as a photoreceptor drum which is electrically charged, the electrostatic latent image is turned into a visible image by a liquid developer with toner particles dispersed in carrier liquid, thereby forming a toner image, and the toner image is transferred to paper through an intermediate transfer body, thereby obtaining a given image, has been put to practical use. Further, in this image forming apparatus, in order to remove excess developer including excess carrier liquid or fogging toner from the toner image formed on the latent image carrier drum by development, a squeeze roller is used. In particular, in recent years, there has been proposed an apparatus which is provided with a plurality of squeeze rollers in order to sufficiently remove excess carrier Liquid from a toner image (for example, JP-A.-2009-251136 (FIG. 2)). In the apparatus disclosed in JP-A-2009-251136, a first squeeze roller and a second squeeze roller are disposed along the rotation direction of a drum-shaped latent image carrier and respectively rotate in a given direction, thereby removing electrical charging fogging or excess carrier liquid on a photoreceptor.

Incidentally, in a case where a technique of using a squeeze roller in this manner is applied to an image forming apparatus having a so-called lower transfer structure in which a transfer process of an image developed by a liquid developer is performed further on the lower side in the vertical direction than an imaginary horizontal plane passing through the rotation center of a latent image carrier drum, the following problems sometimes arise. That is, in the image forming apparatus having the lower transfer structure, there is a high possibility of disposing the squeeze roller at a relatively high position, that is, further on the upper side in the vertical direction than the imaginary horizontal plane. Then, when excess liquid developer has been removed by the squeeze roller, the liquid developer stays at a contact portion between the squeeze roller and the latent image carrier drum, so that a liquid puddle is formed. For this reason, depending on the disposition position of the squeeze roller, there is a possibility that the liquid developer constituting the liquid puddle may run down the surface of the latent image carrier by its own weight and move to a development section, an exposure section, an electrical charging section, or the like, thereby causing deterioration in image quality, contamination in the apparatus, or the like.

### SUMMARY

An advantage of some aspects of the invention is that it prevents deterioration in image quality or contamination in an apparatus by a liquid developer which stays between a squeeze roller and a latent image carrier drum in an image forming apparatus and an image forming method, in which excess liquid developer is squeezed by the squeeze roller which is disposed further on the upper side in the vertical direction than an imaginary horizontal plane passing through the rotation center of the latent image carrier drum.

According to a first aspect of the invention, there is provided an image forming apparatus including: a latent image carrier drum which carries a latent image; a developing roller which comes into contact with the latent image carrier drum on a first side with respect to an imaginary vertical plane passing through the rotation center of the latent image carrier drum, thereby developing the latent image which is carried on the latent image carrier drum by a liquid developer that includes toner and carrier liquid; and a squeeze roller which comes into contact with the latent image carrier drum developed by the developing roller, on a second side on the opposite side to the first side with respect to the imaginary vertical plane further on the upper side in the vertical direction than an imaginary horizontal plane passing through the rotation center of the latent image carrier drum and perpendicular to the imaginary vertical plane, thereby squeezing an image developed to the latent image carrier drum.

According to a second aspect of the invention, there is provided an image forming method including: developing a latent image which is carried on a latent image carrier drum by a liquid developer that includes toner and carrier liquid, by bringing a developing roller into contact with the latent image carrier drum on a first side with respect to an imaginary vertical plane passing through the rotation center of the latent image carrier drum; and squeezing an image developed. by the developing roller, by bringing a squeeze roller into contact with the image on a second side on the opposite side no the first side with respect to the imaginary vertical plane further on the upper side in the vertical direction than an imaginary horizontal plane passing through the rotation center of the latent image carrier drum and perpendicular to the imaginary vertical plane.

In the invention (the image forming apparatus and the image forming method) configured in this manner, the squeeze roller comes into contact with the latent image carrier drum, and the liquid developer stays at the contact portion, so that a liquid puddle is sometimes formed. However, the position of the liquid puddle is lower than a position (the top position) intersecting the imaginary vertical plane on the upper side in the vertical direction of the latent image carrier drum and is disposed on the second side on the opposite side to the disposition side (the first side) of the developing roller with respect to the imaginary vertical plane. For this reason, the liquid developer does not flow from the liquid puddle position to the developing roller side beyond the top position, so that it is possible to prevent deterioration in image quality or contamination in the apparatus.

### BRIEF DESCRIPTION OF THE DRAWINGS

The invention will be described with reference to the accompanying drawings, wherein like numbers reference like elements.

FIG. 1 is a diagram showing a first embodiment of an image forming apparatus related to the invention.

FIG. 2 is a diagram showing a disposition relationship between a photoreceptor drum and a squeeze roller.

FIG. 3 is a diagram showing a disposition relationship between the photoreceptor drum and a blanket roller.

FIG. 4 is a diagram showing an operation of each section of the apparatus at the time of the stop of a printing operation in the first embodiment.

FIG. 5 is a diagram showing separation and contact states of each roller at separation timing of a second squeeze roller.

FIG. 6 is a diagram showing separation and contact states of each roller at the time of the stop of printing.

FIG. 7 is a diagram showing an operation of each section of the apparatus in a second embodiment of she image forming apparatus related to the invention.

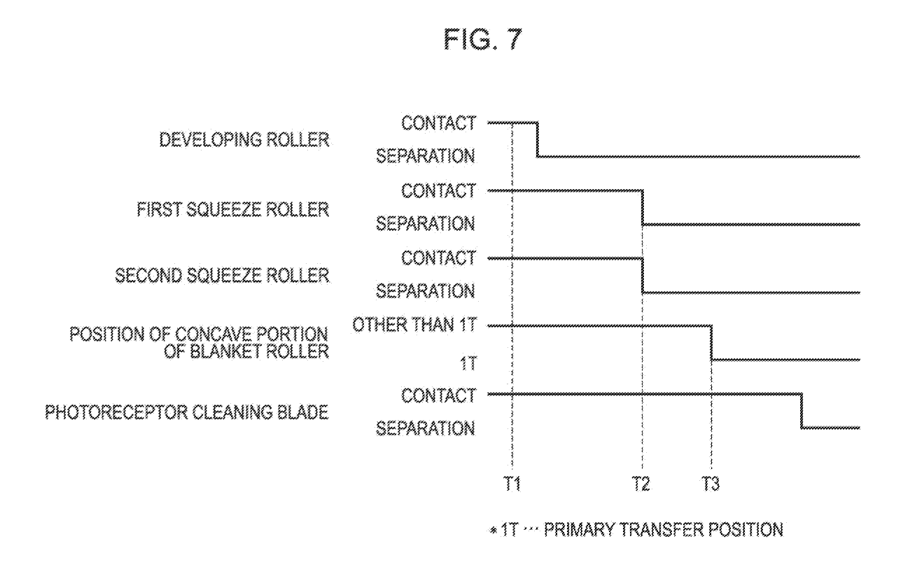

FIG. 8 is a diagram showing a third embodiment of the image forming apparatus related to the invention.

FIG. 9 is a perspective view showing a disposition relationship between the photoreceptor drum and a second squeeze section.

FIG. 10 is a front view showing the disposition relationship between the photoreceptor drum and the second squeeze section.

FIGS. 11A and 11B are diagrams showing an operation of the second squeeze section that is one embodiment of a recovery device.

FIG. 12 is a fragmentary enlarged view of the second squeeze section.

FIG. 13 is a diagram showing a fourth embodiment of the image forming apparatus related to the invention.

FIG. 14 is a perspective view showing a disposition relationship between the photoreceptor drum and a first squeeze section.

FIG. 15 is a front view showing the configuration of the first squeeze section that is one embodiment of the recovery device.

FIG. 16 is a diagram showing an operation of the first squeeze section shown in FIG. 15.

### DESCRIPTION OF EXEMPLARY EMBODIMENTS

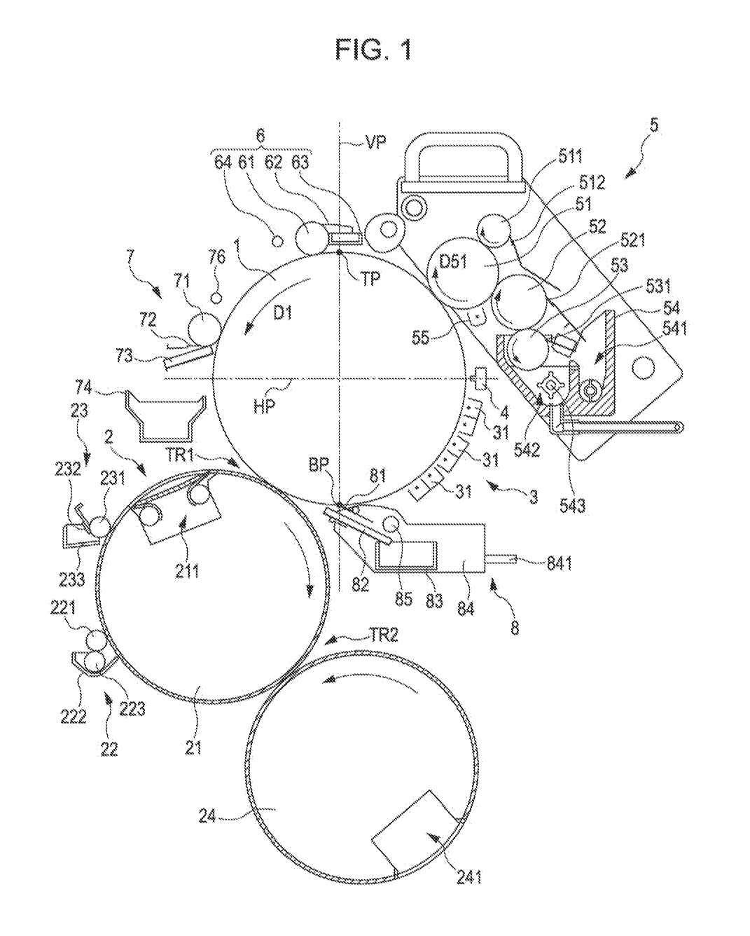

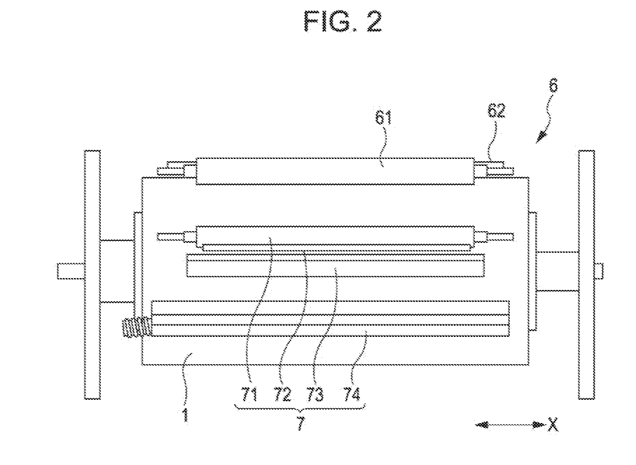

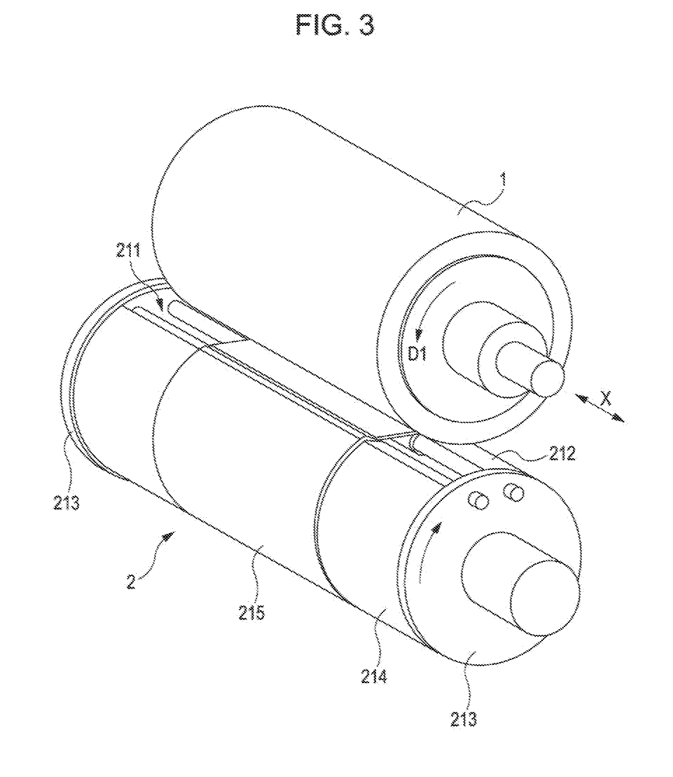

FIG. 1 is a diagram showing a first embodiment of an image forming apparatus related to the invention, FIG. 2 is a diagram showing a disposition relationship between a photoreceptor drum and a squeeze roller, and FIG. 3 is a diagram showing a disposition relationship between the photoreceptor drum and a blanket roller. The image forming apparatus has a so-called lower transfer structure in which an image that is carried by a photoreceptor drum 1 is transferred to a blanket roller 21 of a primary transfer section 2 further on the lower side in the vertical direction than an imaginary horizontal plane HP passing through the rotation center of the photoreceptor drum 1 and the image transferred to the blanket roller 21 is then transferred to transfer paper. In addition, the image forming apparatus of FIG. 1 is for forming a monochromatic toner image and transferring it to the transfer paper, as will be described later, and it is possible to constitute a color printing system by arranging a plurality of, for example, four, apparatuses having the same structure. Of course, the apparatus of FIG. 1 also independently functions as a monochrome image forming apparatus.

In the image forming apparatus, the photoreceptor drum 1 has, on the surface thereof, a photosensitive layer made of a photoreceptor material such as an amorphous silicon photoreceptor. Then, the photoreceptor drum 1 is disposed such that the rotating shaft thereof is parallel or approximately parallel to a main scanning direction X (a direction perpendicular to the plane of the page of FIG. 1), and is rotationally driven at a given speed in a direction of an arrow D1 in FIG. 1.

An electrical charging section 3 which electrically charges the surface of the photoreceptor drum 1 to a given electric potential, an exposure section 4 which exposes the surface of the photoreceptor drum 1 depending on an image signal, thereby forming an electrostatic latent image, a development section 5 which develops the electrostatic latent image by a liquid developer, thereby forming a toner image, a first squeeze section 6, a second squeeze section 7, the blanket roller 21 of the primary transfer section 2, and a photoreceptor cleaning section 8 which cleans the surface of the photoreceptor drum 1 after a primary transfer are disposed around the photoreceptor drum 1 in this order along the rotation direction D1 (in FIG. 1, the counterclockwise direction) of the photoreceptor drum 1.

The electrical charging section 3 has six electric chargers 31 and is disposed on the right side with respect to an imaginary vertical plane VP passing through the rotation center of the photoreceptor drum 1 and on she lower side in the vertical direction with respect to the imaginary horizontal plane HP passing through the rotation center of the photoreceptor drum 1 in the plane of the page of FIG. 1 The electric chargers 31 do not come into contact with the surface of the photoreceptor drum 1 and six are arranged along the rotation direction D1 of the photoreceptor drum 1. As the electric charger 31, for example, a corona electrical charger which is well-known and commonly used in the related art can be used. In the case of using a scorotron charger as the corona electrical charger, a wire current flows through a charge wire of the scorotron charger and also a direct current (DC) grid charging bias is applied to a grid. In this manner, the photoreceptor drum 1 is electrically charged by corona discharge by the electric chargers 31, whereby the electric potential of the surface of the photoreceptor drum 1 is set to be approximately a uniform potential.

The exposure section 4 is disposed on the right side with respect to the imaginary vertical plane VP and on the imaginary horizontal plane HP in the plane of the page of FIG. 1 and exposes the surface of the photoreceptor drum 1 by an optical beam depending on an image signal given from an external, apparatus, thereby forming an electrostatic latent image corresponding to the image signal. In this embodiment, as the exposure section 4, a line head in which light-emitting elements are arranged in the main scanning direction (a direction perpendicular to the plane of the page of FIG. 1) is used. However, apart from this, a device for scanning an optical beam from a semiconductor laser in the main scanning direction by a polygon mirror or the like may also be used. In addition, although in this embodiment, the exposure section 4 is disposed on the imaginary horizontal plane HP, the disposition position of the exposure section 4 is not limited thereto and the exposure section 4 may also be disposed vertically above or below the imaginary horizontal plane HP.

The liquid developer is imparted from the development section 5 to the electrostatic latent image formed in this way, so that the electrostatic latent image is developed by toner. In this embodiment, a liquid developer in which as toner particles, colored resin particles are dispersed in weight ratio of about 25% in carrier liquid containing insulating liquid as its main component is used, and the toner particle has an electric charge capable of being electrophoresed in an electric field. In addition, the concentration of the developer is not limited to 25% as described above and may also be in a range of 10% to 30%. Further, as the carrier liquid, for example, isopar (a trademark of Exxon Corporation), silicon oil, normal paraffin oil, or the like is used. Further, it is preferable that an electrical resistance value be 10¹⁰ Ω·cm or more, more preferably, 10¹² Ω·cm or more. This is because, in a case where resistance is low, excess electric current flows in the process of electrophoresis of the toner particle, so that there is a possibility that an electric field required for movement may not be maintained. Further, the viscosity of the liquid developer prepared in this way depends on resin constituting the toner particle, dispersant, or a charge control agent. However, a liquid developer having viscosity in a range of 50 to 500 [mPa·s] can be used, and in this embodiment, a liquid developer having viscosity of 400 [mPa·s] is used.

The development section 5 of this image forming apparatus is disposed vertically above the electrical charging section 3 on the right side with respect to the imaginary vertical plane VP in the plane of the page of FIG. 1 and has as main components thereof, a developing roller 51, an intermediate application roller 52, an anilox roller 53, a developer container 54 in which the liquid developer described above is stored, and a toner compression corona generator 55 which performs electrical charging and compression actions on the liquid developer. Among these main components, the developing roller 51 is a cylindrical member and has an elastic layer such as polyurethane rubber, silicon rubber, or HER provided on an outer circumferential portion of an inner core made of metal such as iron, and a PFA tube or a resin coating provided on the surface layer of the developing roller, that is, on an outer circumferential portion. The developing roller 51 is connected no a motor for development (not shown) and is rotationally driven in a clockwise direction D51 in the plane of the page of FIG. 1, thereby rotating in an accompanying direction with respect to the photoreceptor drum 1. Further, the developing roller 51 is electrically connected to a development bias generation section (not shown) and is configured such that a development bias is applied thereto at an appropriate timing.

Further, in order to supply the liquid developer to the developing roller 51, the intermediate application roller 52 and the anilox roller 53 are provided, and the liquid developer is supplied from the anilox roller 53 to the developing roller 51 through the intermediate application roller 52. Of these, the intermediate application roller 52 has an elastic layer provided on an outer circumferential portion of an inner core made of metal, similarly to the developing roller 51, whereas the anilox roller 53 is a roller in which a concave portion pattern by a spiral groove or the like finely and uniformly carved out in the surface thereof is formed so as to easily carry the liquid developer. Of course, as the anilox roller 53, similarly to the developing roller 51 or the intermediate application roller 52, a roller in which a rubber layer such as urethane or NBR is wound on a metal core, a roller covered with a PFA tube, or the like may also be used. The intermediate application roller 52 and the anilox roller 53 are connected so the above-mentioned motor for development and respectively rotated in the clockwise direction and the counterclockwise direction in the plane of the page of FIG. 1. Therefore, the intermediate application roller 52 rotates in a counter direction with respect to the developing roller 51 and the anilox roller 53 rotates in an accompanying direction with respect to the intermediate application roller 52. In this manner, in this embodiment, since the liquid developer is supplied from the developer container 54 to the developing roller 51 by a so-called three-roller configuration, the liquid developer passers through nips plurality times, whereby the liquid developer can be sufficiently kneaded, so that it becomes possible to form an even liquid developer film by the developing roller 51. Of course, it is not limited to this form and a configuration (a two-roller configuration) is also acceptable in which the liquid developer is directly applied from the anilox roller 53 to the developing roller 51.

Further, a cleaning roller 511 comes into contact with the developing roller 51 and a roller cleaning blade 512 then comes into contact with the cleaning roller 511, whereby a cleaning process of the developing roller 51 is carried out. That is, the cleaning roller 511 is rotated in the clockwise direction in the plane of the page of FIG. 1 while coming into contact with she surface of the developing roller 51 on the downstream side in the rotation direction D51 of the developing roller with respect. to a development position where the surface of the developing roller 51 comes into contact with the photoreceptor drum 1, thereby forming a development nip. Therefore, the cleaning roller 511 rotates in a counter direction with respect to the developing roller 51, thereby removing the liquid developer remaining on the developing roller 51 without contributing to development. Further, the roller cleaning blade 512 comes into contact with the surface of the cleaning roller 511, thereby scraping off and removing the liquid developer. Further, a cleaning blade 521 comes into contact with the intermediate application roller 52, thereby scraping off and removing the liquid developer remaining on the intermediate application roller 52 without contributing to development, from the surface of the intermediate application roller 52. In addition, the liquid developer scraped off by the cleaning blades 512 and 521 is guided and collected into a recovery section 541 of the developer container 54.

On the other hand, a regulation member 531 comes into contact with the anilox roller 53. As the regulation member 531, a member made of metal or constituted by covering an elastic body on the surface thereof so as to have elasticity can be used. However, the regulation member 531 related to this embodiment is constituted by a rubber portion made of urethane rubber or the like, which comes into contact with the surface of the anilox roller 53, and a plate made of metal or the like, which supports the rubber portion. Then, the regulation member 531 has a function to regulate and adjust the film thickness, the amount, or the like of the liquid developer carried and transported by the anilox roller 53, thereby adjusting the amount of the liquid developer which is supplied to the developing roller 51. Further, the liquid, developer scraped off by the regulation member 531 is returned to a storage section 542 of the developer container 54. In addition, an agitating member 543 is disposed in the storage section 542 and rotated by a motor (not shown), thereby agitating the liquid. developer in the storage section 542.

As described above, the developing roller 51 with the liquid developer supplied thereto rotates so as to move in the opposite direction to the surface of the intermediate application roller 52 and also rotates so as to move in the same direction as the surface of the photoreceptor drum 1. In addition, in order to form the toner image, the rotation direction of the developing roller 51 needs to rotate in an accompanying direction such that the surface thereof moves in the same direction as the surface of the photoreceptor drum 1. However, a configuration is also acceptable in which the developing roller 51 moves in either the opposite direction or the same direction with respect to she intermediate application roller 52.

Further, the toner compression corona generator 55 is disposed along the rotation direction of the developing roller 51. More specifically, the toner compression corona generator 55 is disposed on the upstream side in the side in the rotation direction D51 of the developing roller with respect to the development position. The toner compression corona generator 55 is an electric field application section which increases a bias of the surface of the developing roller 51, and the toner of the liquid developer which is transported by the developing roller 51 is subjected to application of an electric field, electrical charging, and compression at a position close to the toner compression corona generator 55. In addition, for the electrical charging and the compression of the toner, in place of corona discharge by electric field application, a compaction roller to electrically charge toner by contact may also be used.

Further, the development section 5 configured in this manner is connected to a developing device separation and contact mechanism (not shown), and according so transmittance of a control command from a control section (not shown) that controls the whole of the apparatus to the developing device separation and contact mechanism, the development section 5 is turned in the clockwise direction in the plane of the page of FIG. 1 with a turning shaft 56 as a turning center, thereby being capable of reciprocating between the development position (a solid line position in FIG. 1) where a latent image on the photoreceptor drum 1 is developed and a retreat position (not shown) away from the photoreceptor drum 1. Therefore, if the development section 5 is moved to and positioned at the retreat position, during this time, supply of a new liquid developer to the photoreceptor drum 1 is stopped.

The first squeeze section 6 is disposed on the downstream side of the development position in the rotation direction D1 of the photoreceptor drum 1 and also the second squeeze section 7 is disposed on the downstream side of the first squeeze section 6. In this embodiment, both a squeeze roller 61 of the first squeeze section 6 and a squeeze roller 71 of the second squeeze section 7 are disposed on the left side with respect to the imaginary vertical plane VP in the plane of the page of FIG. 1 and on the upper side in the vertical direction with respect to the imaginary horizontal plane HP.

In the first squeeze section 6, the squeeze roller 1 biased in a direction of the photoreceptor drum 1 by a spring (not shown) is provided. That is, a first squeeze position where the squeeze roller 61 comes into contact with the photoreceptor drum 1 is lower than a top position TP intersecting the imaginary vertical plane VP on the upper side in the vertical direction of the photoreceptor drum 1 and further, is on the opposite side (the left side in FIG. 1) to the disposition side (the right side in the same drawing) of the developing roller 51 with respect to the imaginary vertical plane VP. Then, at the first squeeze position, the squeeze roller 61 is rotationally driven by a motor (not shown) while coming into contact with the toner image formed on the surface of the photoreceptor drum 1, thereby removing excess developer of the toner image. Further, in this embodiment, in order to increase squeeze efficiency, a configuration is made such that a first squeeze bias generation section (not shown) is electrically connected so the squeeze roller 61 and a first squeeze bias is applied to the squeeze roller 61 at an appropriate timing. Further, a cleaning blade 62 comes into contact with the surface of the squeeze roller 61, thereby scraping off the liquid developer attached to the surface of the roller. Then, the liquid developer scraped off in this way is collected into a recovery member 63.

Further, the components 61 to 63 constituting the first squeeze section 6 are provided so as to be capable of being turned with a turning shaft 64 as a turning center. Then, if the components 61 to 63 are integrally turned around the turning shaft 64 in The counterclockwise direction in the plane of the page of FIG. 1 by an actuator such as a motor or a solenoid in accordance with an operation command from the control section, the squeeze roller 61 is separated from the photoreceptor drum 1. Conversely, the components 61 to 63 are turned in the clockwise direction, whereby the squeeze roller 61 comes into contact with the photoreceptor drum 1, so that a squeeze process is carried out.

Further, in the second squeeze section 7, at a second squeeze position. on the downstream side of the first. squeeze position in the rotation direction D1 of the photoreceptor drum 1, the squeeze roller 71 rotates while coming into contact with the toner image formed on the surface of the photoreceptor drum 1, thereby removing excess carrier liquid or fogging toner of the toner image. Further, in this embodiment, in order to increase squeeze efficiency, similarly to the first squeeze section 6, a configuration is made such that a second squeeze bias generation section (not shown) is electrically connected to the squeeze roller 71 and a second squeeze bias is applied to the squeeze roller 71 at an appropriate timing. Further, a cleaning blade 72 comes into contact with the surface of the squeeze roller 71, thereby scraping off the liquid developer attached to the surface of the roller. Then, the liquid developer scraped off in this way is guided in a direction away from the photoreceptor drum 1 by a developer receiving member 73 and then collected into a recovery member 74 disposed vertically below the developer receiving member 73.

Also in the second squeeze section 7 configured in this manner, similarly to the first squeeze section 6, the squeeze roller 71, the cleaning blade 72, and the developer receiving member 73 are provided so as to be capable of being integrally turned with a turning shaft 76 as a turning center. Then, if the components 71 to 73 are integrally turned around the turning shaft 76 in the clockwise direction in the plane of the page of FIG. 1 by an actuator such as a motor or a solenoid in accordance with an operation command from the control section (not shown) that controls the whole of the apparatus, the squeeze roller 71 is separated from the photoreceptor drum 1. Conversely, the components 71 to 73 are turned in the counterclockwise direction, whereby the squeeze roller 71 comes into contact with the photoreceptor drum 1, so that a squeeze process is carried out.

On the photoreceptor drum 1 passed through the first and second squeeze sections 6 and 7, the toner image corresponding to the image signal imparted from the outside of the apparatus has been formed, and the toner image is transferred to the blanket roller 21 at a primary transfer position TR1. The transfer section 2 which includes the blanket roller 21 is disposed on the left side with respect to the imaginary vertical plane VP in the plane of the page of FIG. 1 and on the lower side in the vertical direction with respect to the imaginary horizontal plane HP. The transfer section 2 includes the blanket roller 21, a carrier application mechanism. 22 which applies carrier liquid to the blanket roller 21, a cleaning mechanism 23 for the blanket roller 21, and a secondary transfer roller 24.

The blanket roller 21 has a cylindrical shape on the whole, as shown in FIG. 3, and at a portion of the outer circumferential surface thereof, a concave portion 211 is provided. The concave portion 211 is formed by cutting out a portion of the outer circumferential surface of a cylindrical roller base material 212 in a direction X of the rotating shaft of the photoreceptor drum 1. However, the concave portion 211 is not formed at both end portions 213 in the direction X of the rotating shaft of the roller base material 212 and the end portions 213 function as so-called bearers. That is, when the concave portion 211 of the blanket roller 21 faces the photoreceptor drum 1 side, both end portions 213 of the roller base material 212 come into contact with contact members (not shown) mounted on the photoreceptor drum 1 side, thereby preventing a member disposed in the concave portion 211 of the blanket roller 21 from coming into contact with the photoreceptor drum 1.

Further, on the outer circumferential surface of the roller base material 212, an elastic sheet formed by an elastic material such as rubber or resin is wound on a surface area except an area equivalent to the inside of the concave portion 211, and an elastic layer 214 is formed by the elastic sheet. Further, on a central portion of the elastic layer 214 in the direction X of the rotating shaft, a blanket sheet 215 is wound. For this reason, when the elastic layer 214 formed on the area except the concave portion 211 of the outer circumferential surface of the blanket roller 21 is at a position facing the photoreceptor drum 1, the elastic layer 214 is pressed against the photoreceptor drum 1, whereby a primary transfer nip is formed, so that the toner image which is carried on the photoreceptor drum 1 is transferred to the blanket sheet 215. The formation position of the primary transfer nip becomes the primary transfer position TR1. In addition, in a state where the concave portion 211 of the blanket roller 21 faces the photoreceptor drum 1, the primary transfer nip temporarily disappears.

In this embodiment, the primary transfer position TR1 is set on the upstream side in the rotation direction D1 of the photoreceptor drum 1 with respect to the lowermost position of the photoreceptor drum 1 in the vertical direction, that is, a position BP intersecting the imaginary vertical plane VP on the lower side in the vertical direction of the photoreceptor drum 1. Further, the blanket roller 21 is connected to a motor (not shown) and rotationally driven in a clockwise direction D21 in the plane of the page of FIG. 1, thereby rotating in an accompanying direction with respect to the photoreceptor drum 1. In this way, the toner image which is carried on the photoreceptor drum 1 is primary-transferred to the blanket sheet 215 of the blanket roller 21 at the primary transfer position TR1.

Further, the secondary transfer roller 24 rotates in an accompanying direction while coming into contact with the blanket roller 21 on the downstream side of the primary transfer position TR1 in the rotation direction D21 of the blanket roller 21, thereby forming a secondary transfer nip. The secondary transfer roller 24 is also provided with a concave portion 241, similarly to the blanket roller 21. In the concave portion 241, a gripping section (not shown) for gripping a transfer material is disposed. In addition, with respect to the configuration and an operation of the gripping section, for example, a structure in the related art described in JP-A-2010-170005 or the like can be adopted, and the gripping section grips a leading end portion of transfer paper which is transported by a transport section (not shown) and feeds the transfer paper to a secondary transfer position TR2 which is formed as follows.

As shown in FIG. 1, the circumferential surface except the concave portion 241 of the secondary transfer roller 24 comes into contact with the circumferential surface except the concave portion 211 of the blanket roller 21, thereby forming the secondary transfer nip. The formation position of the secondary transfer nip becomes the secondary transfer position TR2. Then, the transfer paper gripped by the gripping section is fed to the secondary transfer position TR2 and passes through the secondary transfer nip, whereby the toner image transferred to the blanket sheet 215 of the blanker roller 21 is secondary-transferred to the transfer paper. In this way, an image using the liquid developer described above is printed on the transfer paper. In addition, when the concave portion 241 of the secondary transfer roller 24 is located at the secondary transfer position TR2, the concave portion 211 of the blanket roller 21 is also located at the secondary transfer position TR2, thereby preventing interference with the gripping section provided in the concave portion 241 of the secondary transfer roller 24.

Further, the carrier application mechanism 22 is disposed on the downstream side of the secondary transfer position TR2 in the rotation direction D21 of the blanket roller 21, thereby applying carrier liquid to the surface of the blanket roller 21 after the secondary transfer. In order to perform an application process of the carrier liquid, the carrier application mechanism 22 has a carrier application roller 221 which rotates in an accompanying direction with respect to the blanket roller 21, a carrier storage member 222 in which the carrier liquid is stored, and a carrier draw-up roller 223 which draws up the carrier liquid from the carrier storage member 222 and supplies it to the carrier application roller 221.

The cleaning mechanism 23 is disposed on the downstream side of the carrier application mechanism 22 and on the upstream side of the primary transfer position TR1 in the rotation direction D21 of the blanket roller 21, thereby cleaning the surface of the blanket roller 21 just before the primary transfer. In order to perform the cleaning process, the cleaning mechanism 23 has a cleaning roller 231 which rotates in a counter direction with respect to the blanket roller 21, a cleaning blade 232 which comes into contact with the cleaning roller 231, thereby cleaning the cleaning roller 231, and a recovery member 233 which recovers the toner or the carrier liquid scraped off by the cleaning blade 232.

The photoreceptor cleaning section 8 is disposed on the downstream side of the primary transfer position TR1 in the rotation direction D1 of the photoreceptor drum 1 and on the upstream side of the electrical charging position. The photoreceptor cleaning section 8 has a cleaning blade 81, a developer receiving member 82 which receives the liquid developer dropping from the lowermost position BP of the photoreceptor drum 1, a recovery member 83 which recovers the developer received in the developer receiving member, and a support member 84 which supports the cleaning blade 81, the developer receiving member 82, and the recovery member 83 in an integrated manner. Then, the support member 84 is made so as to be capable of being turned with a turning shaft 85 as a turning center.

Further, a spring member (not shown) is connected to the support member 84 and biases the support member 84 in the counterclockwise direction in the plane of the page of FIG. 1, thereby acting in a direction of separating the cleaning blade 81 from the photoreceptor drum 1. On the other hand, at an end portion on the opposite side (the right side in FIG. 1) to the photoreceptor drum of the support member 84, an engagement portion 841 is provided to protrude, and if a movable piece (not shown) pushes the engagement portion 841 down by stress larger than the above-mentioned biasing force, the support member 84 is turned in the clockwise direction in the plane of the page of FIG. 1, whereby the cleaning blade 81 moves to the photoreceptor drum side, so that a leading end portion of the cleaning blade 81 comes into contact with the lowermost position BP of the photoreceptor drum 1. In this way, the liquid developer remaining on the photoreceptor drum 1 is cleaned and removed. In addition, the liquid developer scraped off by the cleaning blade 81 in this manner is received by the developer receiving member 82 disposed vertically below the lowermost position BP of the photoreceptor drum 1 and then flows down into the inside of the recovery member 83 along the inclined surface of the developer receiving member 82 and is stored in the recovery member 83.

As described above, in this embodiment, while a printing operation is performed, the developing roller 51 comes into contact with the surface of the photoreceptor drum 1, thereby developing the latent image which is carried on the photoreceptor drums 1, whereby the toner image is formed. Further, the first squeeze roller 61 and the second squeeze roller 71 come into contact with the surface of the photoreceptor drum 1, thereby removing excess liquid developer from the toner image. Then, while the concave portion 211 of the blanket roller 21 is located at a position other than the primary transfer position TR1, the toner image which is carried on the photoreceptor drum 1 is primary-transferred to the blanket sheet 215 of the blanket roller 21. In addition, the cleaning blade 81 of the photoreceptor cleaning section 8 comes into contact with the photoreceptor drum 1, thereby cleaning and removing the liquid developer remaining on the surface of the photoreceptor drum 1 after the primary transfer.

While printing is performed in this manner, at the contact position between the first squeeze roller 61 and the photoreceptor drum 1, that is, the first squeeze position, a liquid puddle of the liquid developer is formed. However, in this embodiment, since the first squeeze roller 61 is disposed on the opposite side (the left side on the plane of the page of FIG. 1) to the disposition side (the right side on the plane of the page of FIG. 1) of the developing roller 51 with respect to the imaginary vertical plane VP and the first squeeze position is lower than the top position TP intersecting the imaginary vertical plane VP on the upper side in the vertical direction of the photoreceptor drum 1, contamination of the development section 5, the exposure section 4, and the electrical charging section 3 by liquid flowing down to the disposition side of the developing roller 51 beyond the top position TP can be prevented, so that it is possible to form an image with excellent image quality.

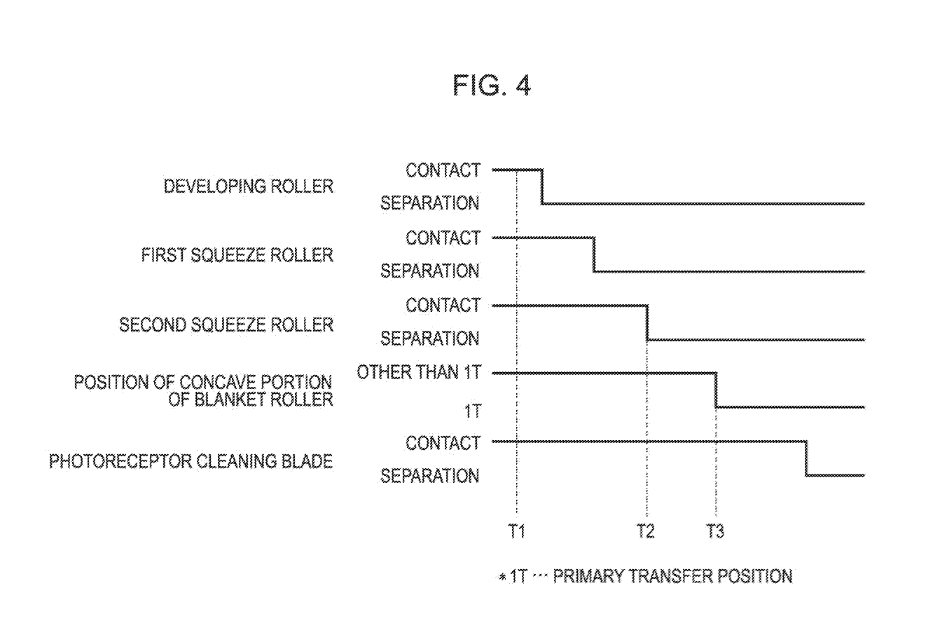

FIG. 4 is a diagram showing an operation timing of each section of the apparatus in the case of stopping a printing operation in the image forming apparatus configured as described above. For example, if a command to stop the printing operation is given an timing T1, the control section controls each section of the apparatus as follows. First, the control section makes the whole of the development section be turned in the clockwise direction in the plane of the page of FIG. 1 with the turning shaft 56 of the development section 5 as a turning center, thereby separating the developing roller 51 from the photoreceptor drum 1. Further, the control section makes the components 61 to 63 of the first squeeze section 6 be integrally turned around the turning shaft 64 in the counterclockwise direction in the plane of the page of FIG. 1, thereby separating the squeeze roller 61 from the photoreceptor drum 1. At this time, a liquid puddle formed at the contact portion between the squeeze roller 61 and the photoreceptor drum 1 is transported to and collected at the second squeeze position. During this time, the second squeeze roller 71 is in contact with the surface of the photoreceptor drum 1, so that the liquid puddle which is transported from the first squeeze position is removed by the second squeeze roller 71.

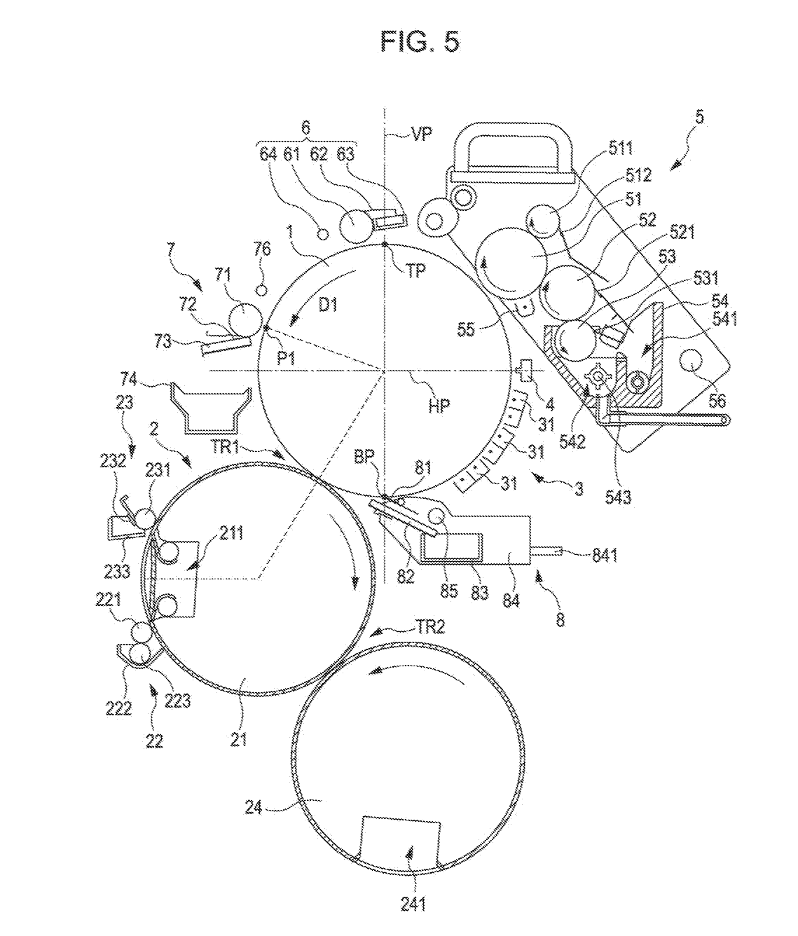

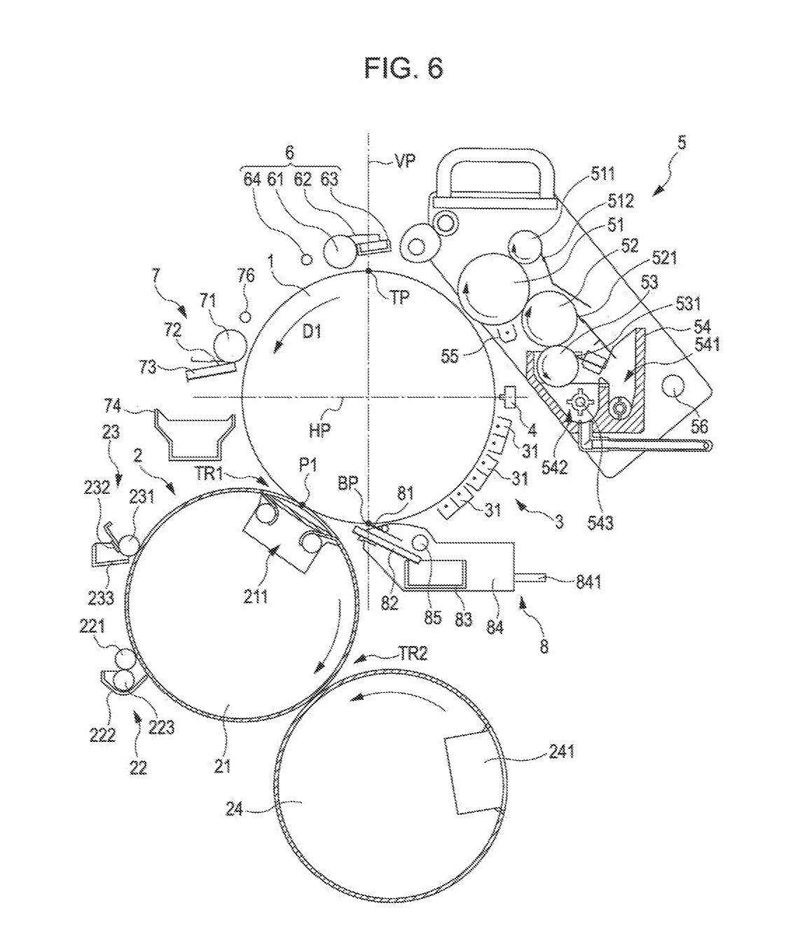

Then, at timing T2 when a given time has elapsed from the separation of the first squeeze roller 61, the control section makes the components 71 to 73 of the second squeeze section 7 be integrally turned around the turning shaft 76 in the clockwise direction in the plane of the page of FIG. 1, thereby separating the squeeze roller 71 from the photoreceptor drum 1 in this way, as shown in FIG. 5, the developing roller 51 and the squeeze rollers 61 and 71 are separated from the photoreceptor drum 1. Further, in this embodiment, in particular, the separation. timing T2 of the second squeeze section 7 is set in association with the position of the concave portion 211 of the blanket roller 21. That is, at a position P1 of the photoreceptor drum 1 which has come into contact with the second squeeze roller 71 at the point of time when the second squeeze section 7 is separated, a liquid puddle of the liquid developer is sometimes formed. Therefore, the control section sets the separation timing of the second squeeze section 7 such that the concave portion 211 of the blanket roller 21 is located at the primary transfer position TR1 at the point of time (timing T3) when the position P1 of the photoreceptor drum 1 reaches the primary transfer position TR1, as shown in FIG. 6. By performing control in this manner, the liquid puddle attached to the position P1 of the photoreceptor drum 1 being transferred to the blanket roller 21, thereby contaminating the blanket roller 21, can be prevented, so that it is possible to keep the apparatus in a clean state. In addition, the liquid puddle attached to the position P1 of the photoreceptor drum 1 is cleaned and removed by the photoreceptor cleaning blade 81, and after this, the control section turns the support member 84 which supports the cleaning blade 81, the developer receiving member 82, and the recovery member 83 in an integrated manner, thereby separating the cleaning blade 81 from the photoreceptor drum 1.

In addition, during the stop of the printing, the developing roller 51, the squeeze rollers 61 and 71, the blanket roller 21, and the cleaning blade 81 are separated from the photoreceptor drum 1, thereby preventing plastic deformation of the surface of the photoreceptor drum 1.

As described above, in this embodiment, the photoreceptor drum 1 is equivalent to a “latent image carrier drum” in the invention, the first squeeze roller 61 is equivalent to a “squeeze roller” in the invention, the second squeeze roller 71 is equivalent to a “second squeeze roller” in the invention, and the blanket roller 21 is equivalent to an “image carrier roller” in the invention. Further, the right side and the left side with respect to the imaginary vertical plane VP in the plane of the page of FIG. 1 are respectively equivalent, to a “first side with respect to the imaginary vertical plane” and a “second side on the opposite side to the first side with respect to the imaginary vertical plane” in the invention.

As described above, a configuration may also be made so as to include a developing roller contact and separation mechanism which brings the developing roller into contact with a latent image carrier drum and separates the developing roller from the latent image carrier drum, a squeeze roller contact and separation mechanism which brings the squeeze roller into contact with the latent image carrier drum and separates the squeeze roller from the latent image carrier drum, and a control section which brings the developing roller and the squeeze roller into contact with the latent image carrier drum by the developing roller contact and separation mechanism and the squeeze roller contact and separation mechanism when performing image formation, and separates the squeeze roller from the latent image carrier drum by the squeeze roller contact and separation mechanism after the developing roller is separated from the latent image carrier drum by the developing roller contact and separation mechanism, when the image formation is ended.

Further, a configuration may also be made such that when a second squeeze roller which performs squeeze in contact with the image squeezed by the squeeze roller on the second side with respect to the imaginary vertical plane is provided, the control section brings the second squeeze roller into contact with the latent image carrier drum when performing image formation, and separates the second squeeze roller from the latent image carrier drum at the same time as the separation of the squeeze roller from the latent image carrier drum or after the separation of the squeeze roller from the latent image carrier drum, when the image formation is ended.

Further, a configuration may also be made such that when an image carrier roller which has a concave portion in the circumferential surface thereof and in which the image squeezed by the squeeze roller is transferred to the circumferential surface further on the lower side in the vertical direction than the imaginary horizontal plane is provided, the control section stops rotation at a position where the concave portion of the image carrier roller faces the latent image carrier drum, when image formation is not performed.

In addition, the invention is not limited to the embodiment described above and it is possible to perform various changes other than those described above without departing from the purpose of the invention. For example, in the above-described embodiment, the first squeeze roller 61 and the second squeeze roller 71 are separated from the photoreceptor drum 1 in this order at different timings. However, a configuration may also be made such that both the squeeze rollers 61 and 71 are separated from the photoreceptor drum 1 after the developing roller 51 is separated from the photoreceptor drum 1. In this case, it is preferable that separation timings of the squeeze rollers 61 and 71 be set to be the timing 12 in the above-described embodiment, and in this way, it is possible to prevent the liquid puddle which is attached to the photoreceptor drum 1 from being attached to the blanket roller 21. Further, a configuration may also be made such that rotation of the blanket roller 21 is stopped at the point of time when the concave portion 211 of the blanket roller 21 is located at the primary transfer position TR1.

Further, in the above-described embodiment, the invention is applied to the image forming apparatus using the two squeeze rollers 61 and 71. However, the invention is also applicable to an image forming apparatus in which the number of squeeze rollers is one or three or more. That is, it is possible to apply the invention to an image forming apparatus and an image forming method in general in which excess liquid developer is squeezed from the photoreceptor drum 1 by the squeeze roller 61 further on the upper side in the vertical direction than the imaginary horizontal plane HP passing through the rotation center of the photoreceptor drum 1.

News, third and fourth aspects of the invention will be described in the past, a liquid development type of image forming apparatus made such that an electrostatic latent image is formed on a latent image carrier drum such as a photoreceptor drum which is electrically charged, the electrostatic latent image is turned into a visible image by a liquid developer with toner dispersed in carrier liquid, thereby forming a toner image, and the toner image is transferred to paper through an intermediate transfer body, thereby obtaining a given image, has been put to practical use. Further, in this image forming apparatus, in order to remove and recover excess liquid developer including excess carrier liquid or fogging toner from the toner image formed on the latent image carrier drum by development, a recovery device using a squeeze roller has been used (for example, JP-A-2010-185984 (FIG. 5)). In the device described in JP-A-2010-185984, the squeeze roller is disposed along the rotation direction of a drum-shaped latent image carrier and rotates in a given direction, thereby removing electrical charging fogging or excess liquid developer on a photoreceptor and collecting it into a recovery member.

Incidentally, the recovery device described above is applied to an image forming apparatus having a so-called upper transfer structure in which a transfer process of an image developed by a liquid developer is performed further on the upper side in the vertical direction than an imaginary horizontal plane passing through the rotation center of a latent image carrier drum. For this reason, it is difficult to directly apply this recovery device to an image forming apparatus having a so-called lower transfer structure in which a transfer process of an image developed by a liquid developer is performed further on the lower side in the vertical, direction than the imaginary horizontal plane. That is, the recovery device needs to perform recovery by bringing a blade into contact with the squeeze roller which removes excess liquid developer or the like from the latent image carrier drum, and in the image forming apparatus described in JP-A-2010-185984, a blade is brought into contact with the squeeze roller at a position of moving from the upper side in the vertical, direction to the lower side. For this reason, the liquid developer which is recovered flows from the upper side in the vertical direction to the lower side and it becomes easy to recover the liquid developer at a desired position by using the flow. In contrast to this, in the image forming apparatus having a lower transfer structure, it is necessary to bring a blade into contact with the squeeze roller at a position of moving from the lower side in the vertical direction to the upper side further on the upper side than the lowermost position in the vertical direction of the squeeze roller, and recovered liquid developer takes a flow pathway different from flow described in JP-A-2010-185984. Therefore, in an apparatus in which a blade comes into contact with the squeeze roller at a position of moving from the lower side in the vertical direction to the upper side further on the upper side than the lowermost position in the vertical direction of the squeeze roller in this manner, a recovery technique suitable for this is required.

Some aspects related to the invention intend to reliably recover a liquid developer in a recovery device which recovers the liquid developer by bringing a blade into contact with a squeeze roller at a position of moving from the lower side in the vertical direction to the upper side further on the upper side than the lowermost position in the vertical direction of the squeeze roller, and an image forming apparatus which is provided with the recovery device.

The third aspect of the invention relates to a recovery device including: a squeeze roller, the surface of which comes into contact with a carrier carrying a liquid developer that includes toner and carrier liquid, thereby recovering the liquid developer, and also moves from a contact position with the carrier to the lower side in the vertical direction; a blade which performs cleaning in contact with the surface of the squeeze roller further on the upper side than the position of a lower end in the vertical direction of the squeeze roller and at the position of the surface of the squeeze roller which moves from the lower side in the vertical direction to the upper side; and a recovery section which is disposed below the position of the lower end in the vertical direction of the squeeze roller, thereby recovering the liquid developer removed from the squeeze roller by the blade.

Further, the fourth aspect of the invention relates to an image forming apparatus including: a latent image carrier drum on which a latent image is formed; a development section which develops the latent image formed on the latent image carrier drum by a liquid developer that includes toner and carrier liquid; and a squeeze section having a squeeze roller, the surface of which comes into contact with the latent image carrier drum developed at the development section, thereby recovering the liquid developer, and also moves from a contact position with the latent image carrier drum to the lower side in the vertical direction, a blade which performs cleaning in contact with the squeeze roller further on the upper side than the position of a lower end in the vertical direction of the squeeze roller and at the position of the surface of the squeeze roller which moves from the lower side in the vertical direction to the upper side, and a recovery section which is disposed below the position of the lower end in the vertical direction of the squeeze roller, thereby recovering the liquid developer removed from the squeeze roller by the blade.

In the invention (the recovery device and the image forming apparatus) configured in this manner, the surface of the squeeze roller comes into contact with the carrier carrying the liquid developer, thereby recovering the liquid developer, and the blade performs cleaning in contact with the squeeze roller further on the upper side than the position of the lower end in the vertical direction of the squeeze roller and at the position of the surface of the squeeze roller which moves from the lower side in the vertical direction to the upper side. In this case, the liquid developer cleaned and removed from the squeeze roller by the blade flows back toward the position of the lower end in the vertical direction of the squeeze roller and falls vertically downward from the position of the lower end by its own weight. Since the recovery section is disposed vertically below the squeeze roller, the liquid developer falling from the position of she lower end is collected into the recovery section.

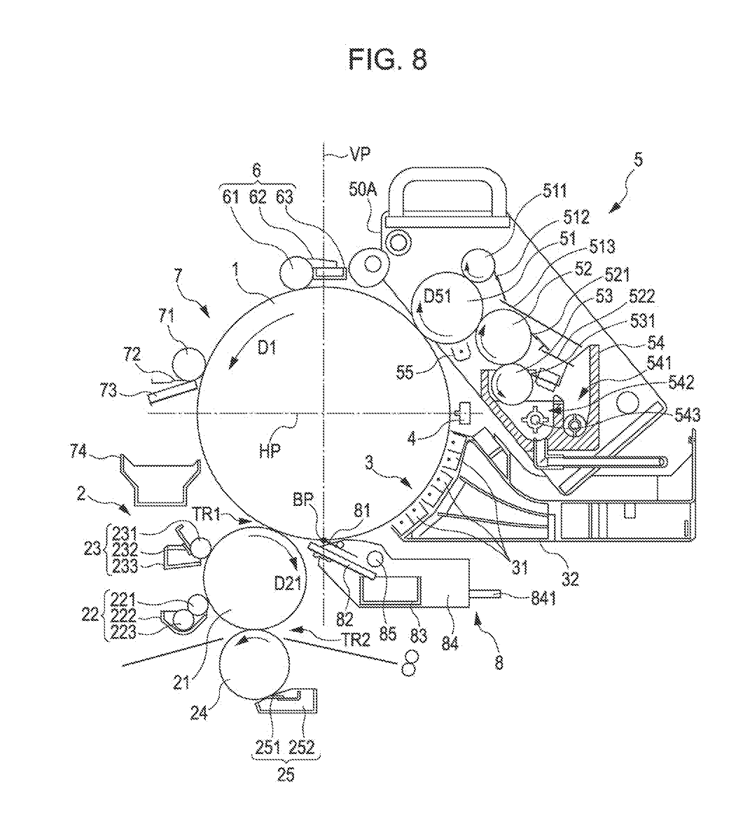

FIG. 8 is a diagram showing a third embodiment of the image forming apparatus related to the invention. In the third embodiment, with respect to particulars common to the first embodiment, explanation is omitted, and with respect to the same site, the same reference numeral as that in FIG. 1 is given and explanation is omitted.

The electrical charging section 3 has an electric charger airflow duct 32, and the electrical charger airflow duct 32 has an outer air introduction pathway (not shown) which introduces outer air toward the electric chargers 31 and an exhaust pathway (not shown) which exhausts an atmosphere that is generated by discharge at the electric chargers 31, and ventilates an atmosphere where an electrical charging process is performed, thereby performing atmosphere control.

The second squeeze section 7 is equivalent to a “recovery device” according to the invention and rotates while the squeeze roller 71 comes into contact with the surface of the photoreceptor drum 1 at the second squeeze position on the downstream side of the first squeeze position in the rotation direction D1 of the photoreceptor drum 1, thereby removing excess liquid developer from the photoreceptor drum 1. In addition, the more detailed configuration and an operation of the second squeeze section 7 will be described in detail later. In addition, although in this embodiment, the two squeeze sections 6 and 7 are provided, the number, disposition, or the like of squeeze sections is not limited thereto, and for example, only the second squeeze section 7 may also be disposed.

On the photoreceptor drum 1 passed through the first and second squeeze sections 6 and 7, the toner image corresponding to the image signal given from the outside of the apparatus has been formed, and the toner image is transferred to the blanket roller 21 at the primary transfer position TR1. The transfer section 2 which includes the blanket roller 21 is disposed on the left side with respect to the imaginary vertical plane VP in the plane of the page of FIG. 8 and on the lower side in the vertical direction with respect to the imaginary horizontal plane HP. The transfer section 2 includes the blanket roller 21, the carrier application mechanism 22 which applies carrier liquid to the blanket roller 21, the cleaning mechanism 23 for the blanket roller 21, the secondary transfer roller 24, and a cleaning section 25 for the secondary transfer roller 24.

The surface of the blanket roller 21 comes into contact with the surface of the photoreceptor drum 1 on the upstream side in the rotation direction D1 of the photoreceptor drum 1 with respect to the lowermost position of the photoreceptor drum 1 in the vertical direction, that is, the position PP intersecting the imaginary vertical plane VP on the lower side in the vertical direction of the photoreceptor drum 1, thereby forming the primary transfer nip. The formation position of the primary transfer nip becomes the primary transfer position TR1. Further, the blanket roller 21 is connected to a motor (not shown) and rotationally driven in the clockwise direction D21 in the plane of the page of FIG. 8, thereby rotating in an accompanying direction with respect to the photoreceptor drum 1. In this way, the toner image which is carried on the photoreceptor drum 1 is primary-transferred to the blanket roller 21 at the primary transfer position TR1.

Further, the secondary transfer roller 24 rotates in an accompanying direction while coming into contact with the blanket roller 21 on the downstream side of the primary transfer position TR1 in the rotation direction 121 of the blanket roller 21, thereby forming the secondary transfer nip. The formation position of the secondary transfer nip becomes the secondary transfer position TR2. Therefore, the transfer paper is fed to the secondary transfer position TR2 by a transport section (not shown) and then passes through the secondary transfer nip, whereby the toner image transferred to the blanket roller 21 is secondary-transferred to the transfer paper. In this way, the image using the liquid developer described above is printed on the transfer paper.

The cleaning section 25 is disposed on the upstream side of the secondary transfer position. TR2 in the rotation direction of the secondary transfer roller 24, thereby cleaning the surface of the secondary transfer roller 24 just before the secondary transfer. In order to perform this cleaning process, the cleaning section 25 has a cleaning blade 251 which comes into contact with the secondary transfer roller 24, thereby cleaning the secondary transfer roller 24, and a recovery member 252 which recovers the toner or the carrier liquid scraped off by the cleaning blade 251.

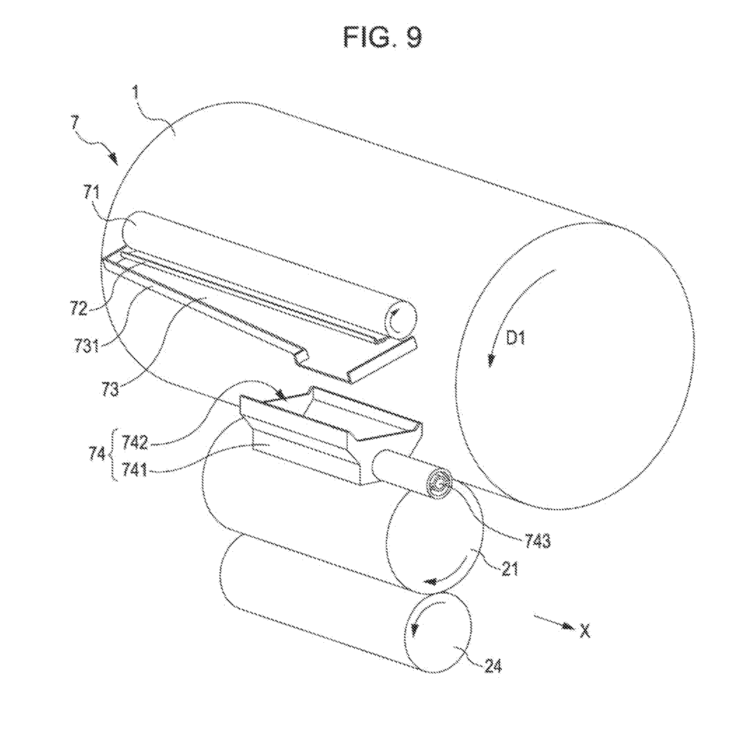

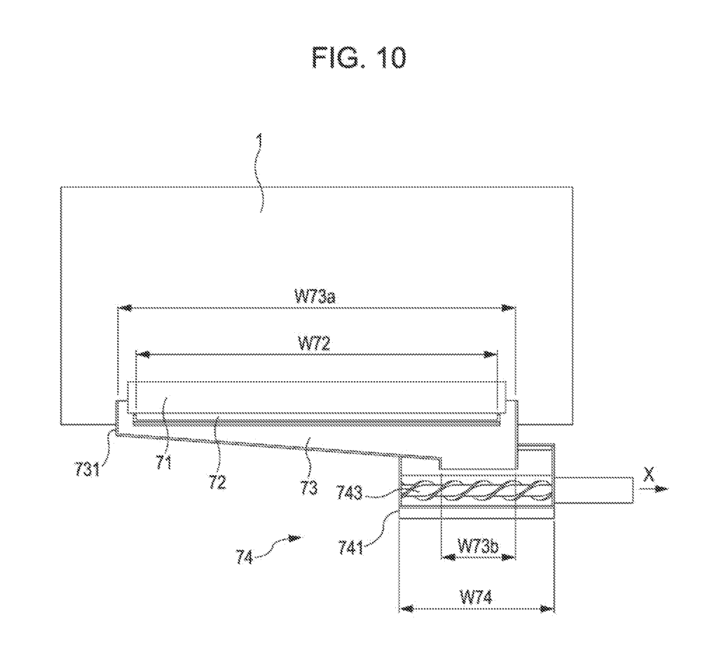

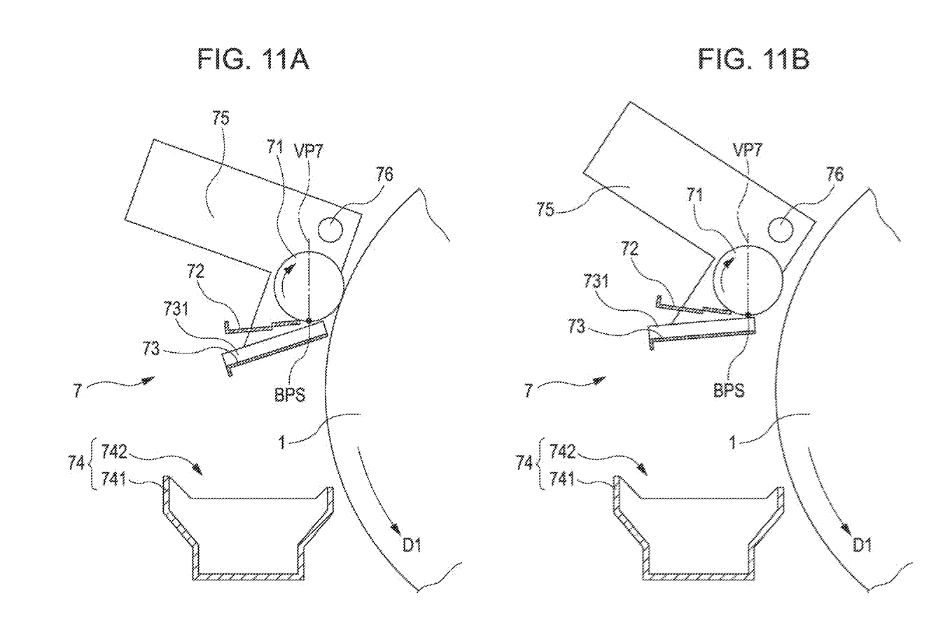

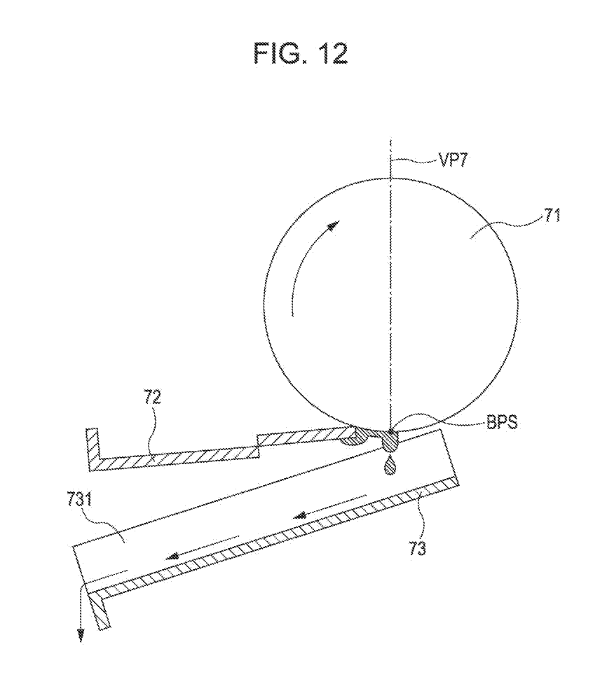

Next, the detailed configuration and an operation of the second squeeze section 7 that is one embodiment of the “recovery device” according to the invention will be described with reference to FIGS. 8 to 12. FIGS. 9 and 10 respectively are a perspective view and a front view showing a disposition relationship between the photoreceptor drum and the second squeeze section. Further, FIGS. 11A and 11B are diagrams showing an operation of the second squeeze section, and FIG. 12 is a fragmentary enlarged view of the second squeeze section. In this embodiment, the second squeeze section 7 is disposed on The left side with respect to the imaginary vertical plane VP in the plane of the page of FIG. 8. However, among the main components thereof, the squeeze roller 71, the cleaning blade 72, and the developer receiving member 73 are disposed on the upper side in the vertical direction with respect to the imaginary horizontal plane HP, while the recovery member 74 is fixedly disposed on the lower side in the vertical direction with respect to the imaginary horizontal plane HP.

In this embodiment, the squeeze roller 71, the cleaning blade 72, and the developer receiving member 73 are disposed in a positional relationship which will he described later, and also supported on a support plate 75. The support plate 75 is pivotally supported with a turning shaft 76 as the center, at a position spaced from the photoreceptor drum 1, as shown in FIGS. 11A and 11B, and made so as to be able to move the squeeze roller 71, the cleaning blade 72, and the developer receiving member 73 in an integrated manner with the turning shaft 76 as the center. The support plate 75 is connected to a contact and separation mechanism (not shown) such as a cylinder or a motor, and the contact and separation mechanism is operated depending on a turning command from a controller, whereby the support plate 75 is turned around the turning shaft 76, thereby bringing the circumferential surface of the squeeze roller 71 into contact with the photoreceptor drum 1 or separating the circumferential surface of the squeeze roller 71 from the photoreceptor drum 1.

If the support plate 75 is turned in the counterclockwise direction in the plane of the page of each of FIGS. 11A and 11B by the contact and separation mechanism, as shown in FIG. 11A, the squeeze roller 71 comes into contact with the photoreceptor drum 1 and rotates in the same direction as the rotation direction of the photoreceptor drum 1, that is, in an accompanying direction with respect to the photoreceptor drum 1. In this way, excess liquid developer is recovered.

Further, the cleaning blade 72 is disposed on the left side (equivalent to a “first side” in the invention) with respect to an imaginary vertical plane VP7 passing through the rotation. center of the squeeze roller 71 in the plane of the page of each of FIGS. 11A and 11B and performs cleaning in contact with the squeeze roller 71 further on the upper side in the vertical direction than a position BPS (that is, a position where the imaginary vertical plane VP7 intersects the circumferential surface of the squeeze roller 71 on the lower side in the vertical direction of the squeeze roller 71) of a lower end in the vertical direction of the squeeze roller 71 and at a position of moving from the lower side in the vertical direction to the upper side. In this way, for example, as shown by a hatched portion in FIG. 12, the liquid developer which is recovered from the circumferential surface of the squeeze roller 71 runs down the surface of the squeeze roller 71 by its own weight, thereby moving to the position BPS of the lower end of the squeeze roller 71, and then falls vertically downward from the position BPS.

In order to reliably recover the thus falling liquid developer while preventing it from being scattered around the photoreceptor drum 1 or the second squeeze section 7, the developer receiving member 73 is provided to extend from vertically below the cleaning blade 72 further to the right side (equivalent to she “second side” in the invention) than the position BPS on the lower side in the vertical direction of the squeeze roller 71, as shown in FIGS. 11A, 11B, and 12. The developer receiving member 73 is made such that an end portion thereof on the squeeze roller side (for example, the right upper side in FIG. 9) is higher in the vertical direction than an end portion thereof on the opposite side (the left lower side in FIG. 9) to the squeeze roller, is inclined vertically downward as it goes away from the squeeze roller 71, and is provided to extend vertically above the recovery member 74. Further, lengths W72 and W73a of the cleaning blade 72 and the end portion on the squeeze roller side of the developer receiving member 73 in the direction of a rotating shaft of the squeeze roller 71, that is, the width direction X are set to be in a relationship of W72<W73a, as shown in FIG. 10. For this reason, if the liquid developer drops from the position BPS of the lower end of the squeeze roller 71, it is received by the end portion on the squeeze roller side of the developer receiving member 73 and flows along the upper surface, that is, an inclined surface of the developer receiving member 73 as recovered liquid.

Further, in the developer receiving member 73, as shown in FIG. 9, side fences (wall portions) 731 are provided in a vertically upward erect manner on both end sides in the width direction X. In addition, each side fence 731 is provided to extend toward the end portion on the opposite side (the left lower side in the same drawing) to the squeeze roller of the developer receiving member 73 and guides the liquid developer to the upper side in the vertical direction of the recovery member 74. Therefore, the liquid developer (the recovered liquid) recovered by the developer receiving member 73 drops from the end portion on the opposite side to the squeeze roller of the developer receiving member 73 into the recovery member 74 without falling to the outside of the second squeeze section 7.

The recovery member 74 has a container 741 in which the liquid developer is stored, and a recovery opening 742 is provided on the upper side in the vertical direction of the container 741. Then, the container 741 is disposed in such a manner that the end portion on the opposite side to the squeeze roller of the developer receiving member 73 is located vertically above the recovery opening 742. For this reason, the liquid developer which drops, from the end portion on the opposite side to the squeeze roller of the developer receiving member 73 is reliably collected into the recovery member 74. Further, in the inside of the container 741, as shown in FIG. 10, the liquid developer is transported in one direction X parallel to the direction X of the rotating shaft of the squeeze roller 71 by an auger (a recovery screw) 743 and flows out of a transport hole (not shown) opened in the side surface of the recovery section 541.

Further, as shown in FIGS. 9 and 10, a distance between both the side fences 731 in the width direction X becomes narrower as it goes to the opposite side to the squeeze roller, and a length W73b in the width direction X of the end portion on the opposite side to the squeeze roller is made narrower than the length W73a in the width direction X of the end portion on the squeeze roller side. Therefore, the liquid developer recovered by the developer receiving member 73 can be efficiently collected without spreading. Further, it is possible to shorten a recovery path in the width direction X, so that it is possible to attain compactification of the recovery member 74. In addition, the end portion on the opposite side to the squeeze roller of the developer receiving member 73 is located on the downstream side in a direction X of transporting the liquid developer from the recovery member 74, as shown in FIG. 9. In this manner, since a transport pathway is disposed being shifted to the transport direction X side, it is possible to shorten the length of the transport pathway.

As described above, in this embodiment, since a so-called lower transfer structure in which the blanket roller 21 is disposed vertically below the imaginary horizontal plane HP passing through the rotation center of the photoreceptor drum 1 is adopted, the toner image is transferred to the upper surface of the transfer paper and the transfer paper is transported with an image plane up. Therefore, there are the advantages that it is possible to stably form the toner image and it is possible to transport the transfer paper without touching the image plane. On the other hand, in the second squeeze section 7, as shown in FIG. 12, the cleaning blade 72 comes into contact with the squeeze roller 71 further on the upper side than the position BPS of the lower end in the vertical direction of the squeeze roller 71 and at a position where the surface of the squeeze roller 71 moves from the lower side in the vertical direction to the upper side, thereby cleaning the squeeze roller 71. Therefore, the liquid developer stripped from the surface of the squeeze roller 71 by this cleaning runs down the surface of the squeeze roller 71, thereby flowing back toward the position BPS, and then falls vertically downward from the position BPS by its own weight. Therefore, in this embodiment, the developer receiving member 73 is disposed vertically below the position BPS, thereby receiving the falling liquid developer and also flowing the liquid developer to the upper side in the vertical direction of the recovery member 74 while guiding it by the side fences 731, and collects the liquid developer into the container 741 through the recovery opening 742. In this manner, the developer receiving member 73 and the recovery member 74 serve as a “recovery section” in the invention, thereby allowing the liquid developer falling from the position BPS of the lower end of the squeeze roller 71 to be reliably collected as the recovered liquid.

Further, in the above-described embodiment, the cleaning blade 72 is disposed on the left side (the first side) in the plane of the page of FIG. 11A, 11B, or 12 with respect to the imaginary vertical, plane VP7, whereas the developer receiving member 7 is provided to extend from vertically below the cleaning blade 72 further to the right side (the second side) in the plane of the page of FIG. 11A, 11B, or 12 with respect to the imaginary vertical plane VP7 than the position BPS of the lower end of the squeeze roller 71. For this reason, the liquid developer falling from the position BPS of the lower end in the vertical direction of the squeeze roller 71 can be reliably received and recovered by the developer receiving member 73. Further, even if the liquid developer directly falls from the cleaning blade 72, it is possible to receive and recover the liquid developer by the developer receiving member 73. In particular, as shown in FIGS. 11A and 11B, since the squeeze roller 71 is disposed such that the imaginary vertical plane VP7 is spaced from The photoreceptor drum 1, as described above, the developer receiving member 73 can be provided to extend further to the photoreceptor drum 1 side than the position BPS, which is suitable for achieving the above-mentioned operation and effects.

Further, in the above-described embodiment, if the support plate 75 is turned in the clockwise direction in the plane of the page of each of FIGS. 11A and 11B by the contact and separation mechanism, the squeeze roller 71 is separated from the photoreceptor drum 1, as shown in FIG. 11B. However, even in the separated state, the recovery section (the developer receiving member 73 and the recovery member 74) is located below the position BPS of the lower end in the vertical direction of the squeeze roller 71. For this reason, similarly to the case (FIG. 11A) of a contact state, the liquid developer falling from the position BPS of the lower end in the vertical direction of the squeeze roller 71 can be reliably received by the developer receiving member 73 and collected into the recovery member 74.

As described above, a configuration may also be made such that the blade is disposed on a first side with respect to an imaginary vertical plane passing through the rotation center of the squeeze roller and the recovery section has a developer receiving member which is provided to extend from vertically below the blade further co a second side on the opposite side to the first side with respect to the imaginary vertical plane than the position of the lower end of the squeeze roller on the lower side in the vertical direction of the squeeze roller, thereby receiving the liquid developer, and a recovery member which recovers the liquid developer received by the developer receiving member.

Further, a configuration may also be made such that a contact and separation mechanism which brings the surface of the squeeze roller into contact with the latent image carrier drum or separates the surface of the squeeze roller from the latent image carrier drum is provided, and when the contact and separation mechanism has separated the surface of the squeeze roller from the latent image carrier drum, the developer receiving member is disposed below the position of the lower end in the vertical direction of the squeeze roller.

Further, a configuration may also be made such that the developer receiving member is disposed vertically below the blade and the length of the developer receiving member in the direction of a rotating shaft of the squeeze roller is longer than the length of the blade in the direction of the rotating shaft of the squeeze roller.

Further, a configuration may also be made such that the developer receiving member has wall portions at both ends thereof in the direction of the rotating shaft of the squeeze roller.

Further, a configuration may also be made such that the wall portions disposed at both ends in the direction of the rotating shaft of the squeeze roller guide the liquid developer received by the developer receiving member to the recovery member.

In addition, the invention is not limited to the embodiment described above and it is possible to perform various changes other than those described above without departing from the purpose of the invention. For example, in the above-described embodiment, the recovery member 74 is disposed on the lower side in the vertical direction with respect to the imaginary horizontal plane HP. However, the recovery member 74 may also be disposed on the imaginary horizontal plane HP or on the upper side in the vertical direction with respect to the imaginary horizontal plane HP.

Further, in the above-described embodiment, the second squeeze section 7 is configured such that the squeeze roller 71 of the second squeeze section 7 comes into contact with the photoreceptor drum 1 on the upper side in she vertical direction with respect to the imaginary horizontal plane HP. However, a configuration may also be made such that the squeeze roller 71 comes into contact with the photoreceptor drum 1 on the imaginary horizontal plane HP or on the lower side in the vertical direction with respect to the imaginary horizontal plane HP.

Next, fifth and sixth aspects of the invention will be described. In the past, a liquid development type of image forming apparatus made such that an electrostatic latent image is formed on a latent image carrier drum such as a photoreceptor drum which is electrically charged, the electrostatic latent image is turned into a visible image by a liquid developer with toner dispersed in carrier liquid, thereby forming a toner image, and the toner image is transferred to paper through an intermediate transfer body, thereby obtaining a given image, has been put to practical use. Further, in this image forming apparatus, in order to remove and recover excess liquid developer including excess carrier liquid or fogging toner from the toner image formed on the latent image carrier drum by development, a recovery device using a squeeze roller has been used (for example, JP-A-2010-185984 (FIG. 5)). In the device described in JP-A-2010-185984, the squeeze roller is disposed along the rotation direction of a drum-shaped latent image carrier and rotates in a given direction, thereby removing electrical charging fogging or excess liquid developer on a photoreceptor and collecting it into a recovery member.

Incidentally, the recovery device described above is applied to an image forming apparatus having a so-called upper transfer structure in which a transfer process of an image developed by a liquid developer is performed further on the upper side in the vertical direction than an imaginary horizontal plane passing through the rotation center of the latent image carrier drum. For this reason, it is difficult to directly apply this recovery device to an image forming apparatus having a so-called lower transfer structure in which a transfer process of an image developed by a liquid developer is performed further on the lower side in the vertical direction than the imaginary horizontal plane. That is, the recovery device needs to perform recovery by bringing a blade into contact with the squeeze roller removed excess liquid developer or the like from the latent image carrier drum, and in the image forming apparatus described in JP-A-2010-185984, a blade is brought into contact with the squeeze roller at a position of moving from the upper side in the vertical direction to the lower side. For this reason, the liquid developer which is recovered flows from the upper side in the vertical direction to the lower side and it becomes easy to recover the liquid developer at a desired position by using the flow. Here, in the image forming apparatus having a lower transfer structure, it is difficult to bring a blade into direct contact with the squeeze roller. Further, even if the blade is brought into contact with the squeeze roller, a contact angle of the blade with respect to the squeeze roller (an angle between a vertical imaginary plane extending vertically downward from a contact portion where the blade comes into contact with the squeeze roller and the lower surface in the vertical direction of the blade) is set to be large and the blade must be tilted into a state considerably close to the horizontal and brought into contact with the squeeze roller, so that it is difficult to efficiently recover the liquid developer from the squeeze roller.

Some aspects related to the invention intend to efficiently recover a liquid developer in a recovery device having a squeeze roller that squeezes an image developed by a liquid developer that includes toner and carrier liquid, and an image forming apparatus which is provided with the recovery device.

The fifth aspect of the invention relates to a recovery device including: a squeeze roller which comes into contact with the latent image carrier drum further on the upper side in the vertical direction than the imaginary horizontal plane perpendicular to the imaginary vertical plane passing through the rotation center of the latent image carrier drum carrying an image developed by a liquid developer that includes toner and carrier liquid, thereby squeezing the image; a cleaning roller which cleans the squeeze roller in contact with the squeeze roller, thereby recovering the liquid developer; and a cleaning blade which cleans the cleaning roller in contact with the cleaning roller, thereby recovering the liquid developer.

Further, the sixth aspect of the invention relates to an image forming apparatus including: a latent image carrier drum on which a latent image is formed; a development section which develops the latent image formed on the latent image carrier drum by a liquid developer that includes toner and carrier liquid; and a squeeze section having a squeeze roller which comes into contact with the latent image carrier drum further on the upper side in the vertical direction than the imaginary horizontal plane perpendicular no the imaginary vertical plane passing through the rotation center of the latent image carrier drum, thereby squeezing the image developed at the development section, a cleaning roller which cleans the squeeze roller in contact with the squeeze roller, thereby recovering the liquid developer, and a cleaning blade which cleans the cleaning roller in contact with the cleaning roller, thereby recovering the liquid developer.

In the invention (the recovery device and the image forming apparatus) configured in this manner, the cleaning roller comes into contact with the squeeze roller and the cleaning blade comes into contact with the cleaning roller, so that the liquid developer is recovered in the pathway of (the squeeze roller)—(the cleaning roller)—(the cleaning blade). By providing the cleaning roller in this manner, a distance from a contact position of the cleaning blade to the surface of the latent image carrier drum becomes longer compared to that in an apparatus in the related art, for example, the apparatus described in JP-A-2010-185984. For this reason, the degree of freedom of design of a device which recovers a liquid developer is increased, and for example, a contact angle of the cleaning blade can be set to be small, that is, the cleaning blade can be disposed in an erected state, so that the liquid developer which is recovered flows from the upper side in the vertical direction no the lower side by free fall, and it becomes easy to recover the liquid developer at a desired position by using the flow.

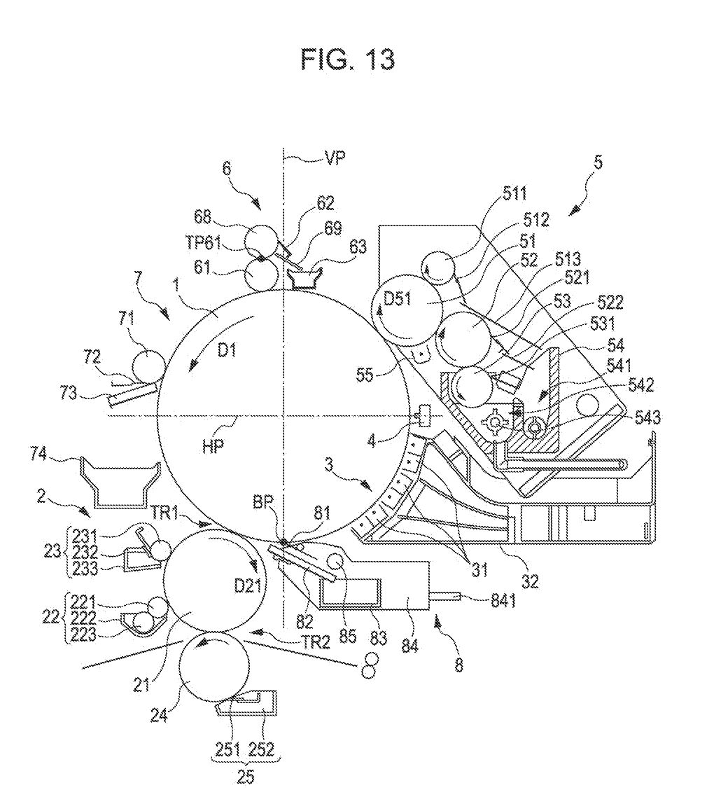

FIG. 13 is a diagram showing a fourth embodiment of the image forming apparatus related to the invention. In the fourth embodiment, with respect to particulars common to the third embodiment, explanation is omitted, and with respect to the same site, the same reference numeral as that in FIG. 8 is given and explanation is omitted.

In this embodiment, the first squeeze section 6 is equivalent, to a “recovery device” according to the invention, and the squeeze roller 61 of the first squeeze section 6 is disposed on the left side with respect to the imaginary vertical plane VP in the plane of the page of FIG. 13 and on the upper side in the vertical, direction with respect to the imaginary horizontal plane HP. Then, the squeeze roller 61 rotates while coming into contact with the surface of the photoreceptor drum 1 at the first squeeze position, thereby removing excess liquid developer from the photoreceptor drum 1. In addition, the more detailed configuration and an operation of the first squeeze section 6 will be described in detail later.

On the other hand, the squeeze roller 71 of the second squeeze section 7 is disposed on the left side with respect to the imaginary vertical plane VP in the plane of the page of FIG. 13 and on the upper side in the vertical direction with respect to the imaginary horizontal plane HP and rotates while coming into contact with the surface of the photoreceptor drum 1 at the second squeeze position on the downstream side of the first squeeze position in the rotation direction D1 of the photoreceptor drum 1 in this manner, thereby removing excess liquid developer from the photoreceptor drum 1. Further, in this embodiment, in order to increase squeeze efficiency, a configuration is made such that a second squeeze bias generation section (not shown) is electrically connected to the squeeze roller 71 and a second squeeze bias is applied to the squeeze roller 71 at an appropriate timing. Further, the cleaning blade 72 comes into contact with the surface of the squeeze roller 71 and scrapes off the liquid developer attached to the surface of the roller, thereby cleaning and removing it. Then, the liquid developer scraped off in this way is guided in a direction away from the photoreceptor drum 1 by the developer receiving member 73 and collected into the recovery member 74 disposed vertically below the developer receiving member 73.

In addition, although in this embodiment, the two squeeze sections 6 and 7 are provided, the number, disposition, or the like of squeeze sections is not limited thereto, and for example, only the first squeeze section 6 may also be disposed.

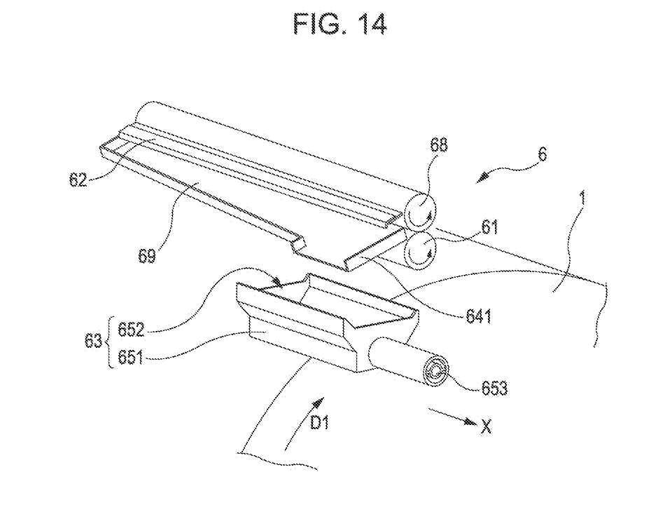

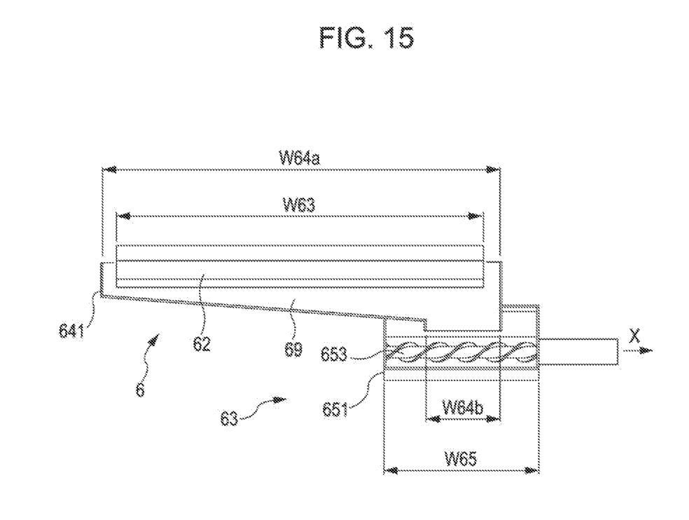

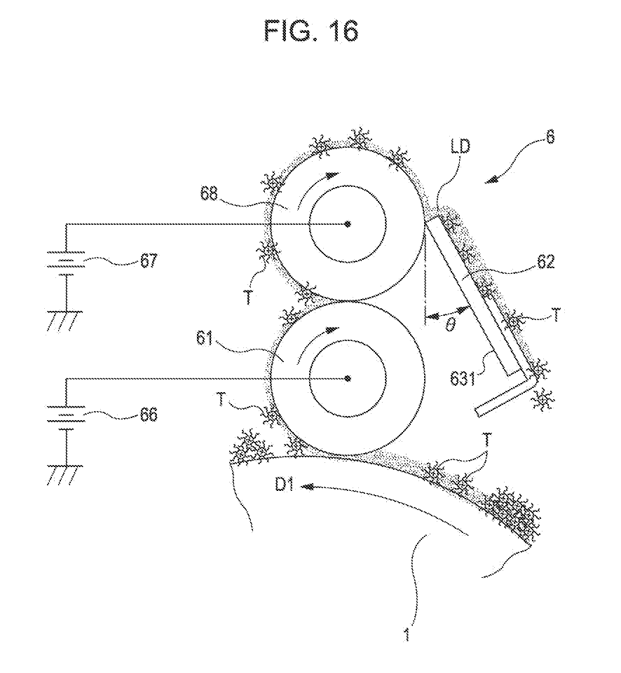

Next, the detailed configuration and an operation of the first squeeze section 6 that is one embodiment of the “recovery device” according to the invention will be described with reference to FIGS. 13 to 16. FIG. 14 is a perspective view showing a disposition relationship between the photoreceptor drum and the first squeeze section, and FIG. 15 is a front view showing the configuration of the first squeeze section that is one embodiment of the recovery device. Further, FIG. 16 is a diagram showing an operation of the first squeeze section. In this embodiment, the first squeeze section 6 has the squeeze roller 61, a cleaning roller 68, the cleaning blade 62, a developer receiving member 69, and the recovery member 63. Among these components, the squeeze roller 61, the cleaning roller 68, the cleaning blade 62, and the developer receiving member 69 are disposed in a positional relationship which will be described later, and also supported by a support plate (not shown). Further, the support plate is pivotally supported with a turning shaft as the center at a position spaced from the photoreceptor drum 1, and made so as to be able to move the squeeze roller 61, the cleaning roller 68, the cleaning blade 62, and the developer receiving member 69 in an integrated manner with the turning shaft as the center. In addition, the support plate is connected to a driving section (not shown) such as a cylinder or a motor, and the driving section operates depending on a turning command from a controller, whereby the support plate is turned around the turning shaft, thereby bringing the circumferential surface of the squeeze roller 61 into contact with the photoreceptor drum 1 or separating the circumferential surface of the squeeze roller 61 from the photoreceptor drum 1.

By turning the support plate in a given direction by the driving section in this manner, the squeeze roller 61 comes into contact with the photoreceptor drum 1 on the left side with respect to the imaginary vertical plane VP in the plane of the page of FIG. 13 and at the first squeeze position on the upper side in the vertical direction with respect to the imaginary horizontal plane HP. Then, the squeeze roller 61 rotates in the same direction as the rotation direction of the photoreceptor drum 1, that is, in an accompanying direction with respect to the photoreceptor drum 1 by a motor (not shown) in contact with the photoreceptor drum 1 at the first squeeze position in this manner. In this way, the squeeze roller 61 squeezes the image developed by the development section 5, thereby recovering excess liquid developer.

The cleaning roller 68 is disposed so as to come into contact with a for position TP61 in the vertical direction of the squeeze roller 61. The cleaning roller 68 rotates by receiving the rotational driving force of the motor in a state where it comes into contact with the squeeze roller 61. In this embodiment, the rotational driving force generated by the motor is imparted to each of the rollers 61 and 68 through a driving force transmission mechanism (not shown), and the cleaning roller 68 rotates faster than the rotating circumferential speed of the squeeze roller 61 and in the same direction as the rotation direction of the squeeze roller 61, that is, in a counter direction with respect to the squeeze roller 61. By setting the rotation direction and the rotating circumferential speed of the cleaning roller 68 with respect to she squeeze roller 61 in this manner, recovery efficiency of the liquid developer from the squeeze roller 61 is increased. From the standpoint of the recovery efficiency, that is, cleaning properties, it is preferable to set a circumferential speed difference [=(the rotating circumferential speed of the cleaning roller 68)−(the rotating circumferential speed of the squeeze roller 61)] to be large. However, even if the circumferential speed difference is set to be large extremely, since a transport amount is determined by the surface tension of the cleaning roller 68, it is saturated somewhere. In the embodiment configured as described above, by setting the rotating circumferential speed of the cleaning roller 68 to be about 1.2 times the rotating circumferential speed of the squeeze roller 61, excellent cleaning properties are secured.

Further, in this embodiment, as shown in FIG. 16, in order to increase squeeze efficiency, a configuration is made such that a first bias generation section 66 and a second bias generation section 67 are respectively electrically connected to the rollers 61 and 68 and at an appropriate timing, a squeeze bias is applied to she squeeze roller 61 and also a cleaning bias is applied to the cleaning roller 68. Here, in a case where the resistance of the squeeze roller 61 is high, since the squeeze roller 61 receives the potential history of the photoreceptor drum or is affected by the cleaning bias which is applied to the cleaning roller 68, it is preferable to set the above-mentioned resistance to be low, and specifically, to set the volume resistivity of the squeeze roller 61 to be equal to or less than 10⁸ [Ω·cm]. However, conversely, if the above-mentioned resistance is too low, since trouble such as flow of excessive current to the photoreceptor drum 1 (for example, trouble in which it is not possible to control the surface potential of the squeeze roller 61 by the applied squeeze bias) occurs, so that development performance is sometimes lowered, in this embodiment, the volume resistivity of the squeeze roller 61 is set to be in a range of 10⁶ to 10⁴ [Ω·cm], thereby securing excellent developability. Further, it is preferable that the volume resistivity of the cleaning roller 68 be also set to be equal to or less than 10⁸ [Ω·cm] corresponding to setting of the volume resistivity of the squeeze roller 61 as described above, and in particular, in a case where the volume resistivity of the squeeze roller 61 is set to be in a range of 10⁶ to 10⁴ [Ω·cm], it is preferable to use the cleaning roller 68 having volume resistivity of 10⁴ [Ω·cm].

Further, it is preferable that the squeeze bias which is imparted to the squeeze roller 61 be set to be in a width of about 450 to 300 [V]. That is, it is preferable to set a squeeze bias to generate an electric field which compresses toner constituting an image to the photoreceptor drum 1 and also attaches fogging toner (symbol T in FIG. 16) onto the squeeze roller 61, within latent image potential contrast that is maintained at the first squeeze position. Further, it is preferable that the cleaning bias which is imparted to the cleaning roller 68 be set such that an electric field in which toner on the squeeze roller 61 moves to the cleaning roller 68 is generated with respect to the squeeze bias. For example, in this embodiment, since the squeeze bias is set to be 350 [V], by setting the cleaning bias to be 250 [V], positively-charged fogging toner moves to the cleaning roller 68, and the toner particles and the attached liquid developer are recovered by the cleaning blade 62.

Further, the cleaning blade 62 is disposed on (or in the vicinity of) an imaginary horizontal plane passing through the rotation center of the cleaning roller 68 in the plane of the page of FIG. 16 and on the right, side with respect to an imaginary vertical, plane passing through the rotation center of the cleaning roller 68 and performs cleaning in contact with the cleaning roller 68 at a position of moving from the upper side in the vertical direction to the lower side. In this way, a liquid developer LD which is recovered from the circumferential surface of the cleaning roller 68 moves to an end portion (an end portion on the right lower side in the same drawing) on the opposite side to the cleaning roller of the cleaning blade 62 along the upper surface in the vertical direction of the cleaning blade 62 by its own weight and falls vertically downward from the end portion, as shown in the same drawing.

In order to reliably recover the thus falling liquid developer while preventing it from being scattered around the photoreceptor drum 1 or the first squeeze section 6, the developer receiving member 69 is disposed vertically below the cleaning blade 62, as shown in FIGS. 14 and 15. The developer receiving member 69 is made such that an end portion thereof on the cleaning roller side (for example, the right upper side in FIG. 14) is higher in the vertical direction than an end portion thereof on the opposite side (the left lower side in FIG. 14) to the cleaning roller, is inclined vertically downward as it goes away from the cleaning roller 68, and provided to extend vertically above the recovery member 63. Further, lengths W63 and W64a of the cleaning blade 62 and the end portion on the cleaning roller side of the developer receiving member 69 in the direction of a rotating shaft of the cleaning roller 68, that is, the width direction X are set to be in a relationship of W63<W64a, as shown in FIG. 15. For this reason, if the liquid developer scraped off from the cleaning roller 68 by the cleaning blade 62 flows along the upper surface of the cleaning blade 62 and drops from the end portion on the opposite side to the cleaning roller of the cleaning blade 62, it is received by the end portion on the squeeze roller side of the developer receiving member 69 and flows along the upper surface, that is, an inclined surface of the developer receiving member 69 as recovered liquid.

Further, in the developer receiving member 69, as shown in FIG. 14, side fences (wall, portions) 611 are provided in a vertically upward erect manner on both end sides in the width direction X. In addition, each side fence 611 is provided to extend toward the end portion on the opposite side (the left lower side in the same drawing) to the cleaning roller of the developer receiving member 69 and guides the liquid developer to the upper side in the vertical direction of the recovery member 63. Therefore, the liquid developer (the recovered liquid) recovered by the developer receiving member 69 drops from the end portion on the opposite side to the cleaning roller of the developer receiving member 69 to the recovery member 63 without failing to the outside of the first squeeze section 6.

The recovery member 63 has a container 651 in which the liquid developer is stored, and a recovery opening 652 is provided on the upper side in the vertical direction of the container 651. Then, the container 651 is disposed in such a manner that the end portion on the opposite side to the cleaning roller of the developer receiving member 69 is located vertically above the recovery opening 652. For this reason, the liquid developer which drops from the end portion on the opposite side to the cleaning roller of the developer receiving member 69 is reliably collected into the recovery member 63. Further, in the inside of the container 651, as shown in FIG. 15, the liquid developer is transported. in one direction X parallel to the direction of the rotating shaft of the squeeze roller 61 by an auger (a recovery screw) 653 and flows out of a transport hole (not shown) opened in the side surface of the recovery section 541.

Further, as shown in FIGS. 14 and 15, a distance between both the side fences 641 in the width direction becomes narrower as it goes to the opposite side to the cleaning roller, and a length W64b in the width direction of the end portion on the opposite side to the cleaning roller is made narrower than the length W64a in the width direction X of the end portion on the cleaning roller side. Therefore, The liquid developer recovered by the developer receiving member 69 can be efficiently collected without spreading. Further, it is possible to shorten a recovery path in the width direction X, so that it is possible to attain compactification of the recovery member 63. In addition, the end portion on the opposite side to the cleaning roller of the developer receiving member 69 is located on the downstream side in a direction X of transporting the liquid developer from the recovery member 63, as shown in FIG. 14. In this manner, since a transport pathway is disposed being shifted to the transport direction X side, it is possible to shorten the length of the transport pathway.

As described above, in this embodiment, since a so-called lower transfer structure in which the blanket roller 21 is disposed vertically below the imaginary horizontal plane HP passing through the rotation center of the photoreceptor drum 1 is adopted, the toner image is transferred to the upper surface of the transfer paper and the transfer paper is transported with an image plane up. Therefore, there are the advantages that it is possible to stably form the toner image and it is possible to transport the transfer paper without touching the image plane. On the other hand, in the first squeeze section 6, a position where the surface of the squeeze roller 61 rotationally moves downward from the top position TP61 in the vertical direction approaches the surface of the photoreceptor drum 1, and if as in an apparatus in the related art, the cleaning blade is made to come into contact with the squeeze roller 61, a distance from the contact position of the blade to the photoreceptor drum 1 is short, so that recovery of the liquid developer becomes difficult.

However, in this embodiment, since the cleaning roller 68 comes into contact with the squeeze roller 61 to recover the liquid developer from the squeeze roller 61 by the cleaning roller 68 and the cleaning blade 62 comes into contact with the cleaning roller 68, a distance from the contact position of the blade to the photoreceptor drum 1 becomes longer compared to that in an apparatus in the related art. Therefore, as shown in FIG. 16, it is possible to set a contact angle θ of the cleaning blade 62 (an angle between a vertical imaginary plane VP6 extending vertically downward from a contact portion where the blade 62 comes into contact with the cleaning roller 68 and a lower surface 631 in the vertical direction of the blade 62) to be small, that is, it is possible to disposed the cleaning blade 62 in an erected state. Then, the liquid developer LD which is recovered by the cleaning blade 62 smoothly flows from the upper side in the vertical direction to the lower side along the upper surface of the cleaning blade 62 by its own weight and is collected into the container 651 of the recovery member 63 through the developer receiving member 69. In this manner, it is possible to efficiently recover the liquid developer by the first squeeze section 6 related to this embodiment.

As described above, a driving section which rotates the cleaning roller in the same direction as the rotation direction of the squeeze roller may also be provided.

Further, a configuration may also be made such that the driving section rotates the cleaning roller at the same speed as the rotating circumferential speed of the squeeze roller or faster than the rotating circumferential speed of the squeeze roller.

Further, a bias generation section which applies bias voltage to the squeeze roller may also be provided

Further, a recovery section which recovers the liquid developer that is removed from the cleaning roller by the cleaning blade may also be provided.

Further, a configuration may also be made such that the recovery section has a developer receiving member which receives the liquid developer that is removed by the cleaning blade, the developer receiving member is disposed vertically below the cleaning blade, and the length of the developer receiving member in the direction of the rotating shaft of the squeeze roller becomes longer than the length of the cleaning blade in the direction of the rotating shaft of the squeeze roller.

Further, a configuration may also be made such that the developer receiving member has wall portions at both ends thereof in the direction of she rotating shaft of the squeeze roller.

In addition, the invention is not limited to the embodiment described above and it is possible to perform various changes other than those described above without departing from the purpose of the invention. For example, in the above-described embodiment, the cleaning roller 68 comes into contact with the squeeze roller 61 at she top position TP61 of the squeeze roller 61. However, the contact position of the cleaning roller 68 with respect to the squeeze roller 61 is not limited thereto. However, from the standpoint of obtaining a distance from the contact position of the cleaning blade 62 with the cleaning roller 68 to the photoreceptor drum 1, it is preferable that the cleaning roller 68 comes into contact with the squeeze roller 61 at a position close to the top position TP61 of the squeeze roller 61.

The entire disclosure of Japanese Patent Application No.2011-035834, filed Feb. 22, 2011, No.2011-097338, filed Apr. 25, 2011 and No.2011-097339, flied Apr. 25, 2011 are expressly incorporated by reference herein.

What is claimed is:

1. An image forming apparatus comprising
a latent image carrier drum which carries a latent image;
a developing roller which comes into contact with the latent image carrier drum on a first side with respect to an imaginary vertical plane passing through the rotation center of the latent image carrier drum, thereby developing the latent image which is carried on the latent image carrier drum by a liquid developer that includes toner and carrier liquid; and
a squeeze roller which comes into contact with the latent image carrier drum developed by the developing roller, on a second side on the opposite side to the first side with respect to the imaginary vertical plane further on the upper side in the vertical direction than an imaginary horizontal plane passing through the rotation center of the latent image carrier drum and perpendicular to the imaginary vertical plane, thereby squeezing an image developed to the latent image carrier drum.

2. The forming apparatus according to claim 1, further comprising:
a developing roller contact and separation mechanism which brings the developing roller into contact with the latent image carrier drum and separates the developing roller from the latent image carrier drum;
a squeeze roller contact and separation mechanism which brings the squeeze roller into contact with the latent image carrier drum and separates the squeeze roller from the latent image carrier drum; and
a control section which brings the developing roller and the squeeze roller into contact with the latent image carrier drum by the developing roller contact and separation mechanism and the squeeze roller contact and separation mechanism when performing image formation, and separates the squeeze roller from the latent image carrier drum by the squeeze roller contact and separation mechanism after the developing roller is separated from the latent image carrier drum by the developing roller contact and separation mechanism, when the image formation is ended.

3. The image forming apparatus according to claims 2, further comprising:
a second squeeze roller which performs squeeze in contact with the image squeezed by the squeeze roller on the second side with respect to the imaginary vertical plane,
wherein the control section brings the second squeeze roller into contact with the latent image carrier drum when performing image formation, and separates the second squeeze roller from the latent image carrier drum at the same time as the separation of the squeeze roller from the latent image carrier drum or after the separation of the squeeze roller from the latent image carrier drum, when the image formation is ended.

4. The image forming apparatus according to claim 2, further comprising:
an image carrier roller which has a concave portion in the circumferential surface thereof and in which the image squeezed by the squeeze roller is transferred to the circumferential surface further on the lower side in the vertical direction than the imaginary horizontal plane,
wherein the control section stops rotation at a position where the concave portion of the image carrier roller faces the latent image carrier drum, when image formation is not performed.

5. An image forming method comprising:
developing a latent image which is carried on a latent image carrier drum by a liquid developer that includes toner and carrier liquid, by bringing a developing roller into contact with the latent image carrier drum on a first side with respect to an imaginary vertical plane passing through the rotation center of the latent image carrier drum; and
squeezing an image developed by the developing roller, by bringing a squeeze roller into contact with the image on a second side on the opposite side to the first side with respect to the imaginary vertical plane further on the upper side in the vertical direction than an imaginary horizontal plane passing through the rotation center of the latent image carrier drum and perpendicular to the imaginary vertical plane.

6. A recovery device which is provided in the image forming apparatus according to claim 1, comprising:
the squeeze roller, the surface of which comes into contact with the latent image carrier drum carrying a liquid developer that includes toner and carrier liquid, thereby recovering the liquid developer, and also moves from a contact position with the latent image carrier drum to the lower side in the vertical direction;
a blade which performs cleaning in contact with the surface of the squeeze roller further on the upper side than the position of a lower end in the vertical direction of the squeeze roller and at the position of the surface of the squeeze roller which moves from the lower side in the vertical direction to the upper side; and
a recovery section which is disposed below the position of the lower end in the vertical direction of the squeeze roller, thereby recovering the liquid developer removed from the squeeze roller by the blade.

7. The image forming apparatus according to claim 1, further comprising:
a development section which develops the latent image formed on the latent image carrier drum by the liquid developer that includes toner and carrier liquid; and
a squeeze section having The squeeze roller, the surface of which comes into contact with the latent image carrier drum developed at the development section, thereby recovering the liquid developer, and also moves from a contact position with the latent image carrier drum to the lower side in the vertical direction, a blade which performs cleaning in contact with the squeeze roller further on the upper side than the position of a lower end in the vertical direction of the squeeze roller and at the position of the surface of the squeeze roller which moves from the lower side in the vertical direction to the upper side, and a recovery section which is disposed below the position of the lower end in the vertical direction of the squeeze roller, thereby recovering the liquid developer removed from the squeeze roller by the blade.

8. The image forming apparatus according to claim 7, wherein the blade is disposed on a first side with respect to an imaginary vertical plane passing through the rotation center of the squeeze roller, and
the recovery section has a developer receiving member which is provided to extend from vertically below the blade further to a second side on the opposite side to the first side with respect to the imaginary vertical plane than the position of the lower end of the squeeze roller on the lower side in the vertical direction of the squeeze roller, thereby receiving the liquid developer, and a recovery member which recovers the liquid developer received by the developer receiving member.

9. The image forming apparatus according to claim 8, further comprising:
a contact and separation mechanism which brings the surface of the squeeze roller into contact with the latent image carrier drum or separates the surface of the squeeze roller from the latent image carrier drum,
wherein when the contact ant separation mechanism has separated the surface of the squeeze roller from the latent image carrier drum, the developer receiving member is disposed below the position of the lower end in the vertical direction of the squeeze roller.

10. The image forming apparatus according to claim 8, wherein the developer receiving member is disposed vertically below the blade and the length of the developer receiving member in the direction of a rotating shaft of the squeeze roller is longer than the length of the blade in the direction of the rotating shaft of the squeeze roller.

11. The image forming apparatus according to claim 8, wherein the developer receiving member has wall portions at both ends thereof in the direction of a rotating shaft of the squeeze roller.

12. The image forming apparatus according to claim 11, wherein the wall portions disposed at both ends in the direction of the rotating shaft of the squeeze roller guide the liquid developer received by the developer receiving member to the recovery member.

13. A recovery device which is provided in the image forming apparatus according to claim 1, comprising:
the squeeze roller which comes into contact with the latent image carrier drum further on the upper side in the vertical direction than the imaginary horizontal plane perpendicular to the imaginary vertical plane passing through the rotation center of the latent image carrier drum. carrying an image developed by a liquid developer that includes toner and carrier liquid, thereby squeezing the image;
a cleaning roller which cleans the squeeze roller in contact with the squeeze roller, thereby recovering the liquid developer; and
a cleaning blade which cleans the cleaning roller in contact with the cleaning roller, thereby recovering the liquid developer.

14. The image forming apparatus according to claim 1, comprising:
a development section which develops the latent image formed on the latent image carrier drum by a liquid developer that includes toner and carrier liquid; and
a squeeze section having the squeeze roller which comes into contact with the latent image carrier drum further on the upper side in the vertical direction than the imaginary horizontal plane passing through the rotation center of the latent image carrier drum and perpendicular to the imaginary vertical plane, thereby squeezing the image developed at the development section, a cleaning roller which cleans the squeeze roller in contact with the squeeze roller, thereby recovering the liquid developer, and a cleaning blade which cleans the cleaning roller in contact with the cleaning roller, thereby recovering the liquid developer.

15. The image forming apparatus according to claim 14, further comprising:
a driving section which rotates the cleaning roller in the same direction as the rotation direction of the squeeze roller.

16. The image forming apparatus according to claim 15, wherein the driving section rotates the cleaning roller at the same speed as the rotating circumferential speed of the squeeze roller or faster than the rotating circumferential speed of the squeeze roller.

17. The image forming apparatus according to claim 14, further comprising:
a bias generation section which applies bias voltage to the squeeze roller.

18. The image forming apparatus according to claim 14, further comprising:
a recovery section which recovers the liquid developer that is removed from the cleaning roller by the cleaning blade.

19. The image forming apparatus according to claim 18, wherein the recovery section has a developer receiving member which receives the liquid developer that is removed by the cleaning blade, and
the developer receiving member is disposed vertically below the cleaning blade, and the length of the developer receiving member in the direction of a rotating shaft of the squeeze roller is longer than the length of the cleaning blade in the direction of the rotating shaft of the squeeze roller.

20. The image forming apparatus according to claim 19, wherein the developer receiving member has wall portions at both ends thereof in the direction of the rotating shaft of the squeeze roller.
